(19) United States
(12) Patent Application Publication
(10) Pub. No.: US 2003/0005056 A1
(43) Pub. Date: Jan. 2, 2003

(54) Interactive networked schedule

(76) Inventors: Takayuki Yamamoto, Yokohama (JP); Masaki Fujiwara, Hitachinaka (JP)

Correspondence Address: MCDERMOTT WILL & EMERY, 600 13TH STREET, N.W., WASHINGTON, DC, 20005-3096, US

(21) Appl. No.: 10/183,055

(22) Filed: Jun. 27, 2002

(30) Foreign Application Priority Data
Jun. 29, 2001 (JP) 2001-198904
Nov. 1, 2001 (JP) 2001-336154
Dec. 14, 2001 (JP) 2001-380842

(51) Int. Cl. G06F 15/16; G06F 17/60

(52) U.S. Cl. 709/205; 345/963; 705/14

(57) ABSTRACT

In a mobile information terminal device, using the network, user's own schedule information is made available to the user by a simplified operation in a short time. Out of a schedule table latched in a memory of the mobile information terminal device, a keyword necessary for the information retrieval is extracted. Moreover, based on this keyword, the schedule-related information is retrieved by a server on the network. Finally, its retrieval result is displayed in association with the schedule in the schedule table.

### BACKGROUND

The present subject matter relates to an information terminal device, a server, and an information delivering device, which are to be connected to a network, and an information delivering method and a software therefor.

In recent years, with the rapid advancement in the digital technologies, there have been increasing occasions of using a mobile information terminal device or the like by a user to manage his or her schedule connecting the mobile information terminal device to the Internet to obtain his or her schedule information at the places where he or she visits on business or the like.

Conventionally, as the method by which a user obtains information via the Internet, the user has usually obtained the information from a Web site into which the user had directly made an inputting or the registration, or from a Web site of the linked address included in a transmitted mail. The Web site that the user utilizes most widely in order to obtain some unknown information is a Web site equipped with a retrieving or search function. Here, the user inputs a retrieving keyword so as to execute the retrieval, thereby fetching the URL (: Uniform Resource Locator) of the corresponding Web site or the corresponding information. Also, the management of the user's schedule using the mobile information terminal device includes substantially the same functions as those of non-electronized pocket-notebooks, such as confirming the time-and-date and contents of a scheduled event as the main function and alarming, synchronizing with another schedule table, and the like as secondary functions.

Meanwhile, such a Web site is never utilized until being visited by the user in the above-described way, and accordingly the Web site is passive in general. Consequently, the manager of the Web site like this generally performs some sort of advertising activities so that as many users as possible will visit his or her Web site. As the methods therefor, the following ones can be mentioned on the network: For example, the manager has his or her Web site registered into a Web site equipped with the retrieving function as described above, has an advertisement published on other Web sites or establishes a tie-up with another Web site so as to have a link set up, transmits a direct mail to specified persons such as members or to a large number of unspecified persons, or the like.

### SUMMARY

When retrieving information by the mobile information terminal device using the Internet, there are many cases where, as compared with the case of retrieving the information by a PC, a sufficient inputting device such as a keyboard is not available and in addition, a display device having a sufficient display capacity is not available, either. Due to these limitations, when performing the information retrieval by the mobile information terminal device via the Internet, confirming the input result and the retrieval result requires so much trouble and labor, thus complicating the operation at the same time. Also, the retrieval based on the Web site equipped with the retrieving function is performed by executing the following complicated operations and many steps, thus taking a time as well: The retrieval inputting operation, the transmission of a retrieving keyword to the Web site, the retrieval at the Web site, and the transmission of the retrieval result to the mobile information terminal device.

Meanwhile, in many cases, the above-described advertising activities for advertising the Web site are generally performed with the target unspecified, i.e., at random. Of the advertising activities, in some cases, there is displayed an advertisement that, depending on the users' interests, histories, or the operation contents, can be guessed to call the concern of the users. The advertising activities, however, are not performed under a condition that the users are specified on each-person basis and the advertising activities are caused to correspond to each user's schedule from the present. As described earlier, there are many cases where a user uses the mobile information terminal for the purpose of the schedule management, and also the information that the user wishes to obtain by the retrieval is information related with the user's schedule. Consequently, if, based on best-fitted timing and method synchronized with the user's schedule, the manager of the Web site can perform the advertising activity toward the user, the effect can be considered to become exceedingly greater than the effect based on the usual advertising activities.

In view of the above-described prior arts, a problem is, in a mobile information terminal device, to make user's schedule information available to the user by a simplified operation, in a short time, and using the network.

Also, in view of the above-described prior arts, another problem is to allow the manager of a Web site to perform an advertising activity of the manager's Web site to the mobile information terminal device in synchronization with the user's schedule.

In order to solve the above-described problems, an information terminal device and software executed in the information terminal device have a forming function for forming a schedule pack based on schedule data inputted by an user and stored in a memory of the information terminal device, and a transmitting function for transmitting the schedule pack to a server via the network. The server receiving the schedule pack, has a retrieving function for retrieving schedule-related information by using the schedule pack, and transmitting function for transmitting the retrieved schedule-related information. Also, the information terminal device receiving the schedule-related information and the software executed in the information terminal device receiving the schedule-related information have a display function for displaying schedule-related information retrieved by the server by using the schedule pack.

Furthermore, the display function may display the retrieved schedule-related information in association with the schedule data. In order to display the retrieved schedule-related information in association with the schedule data, the server may have a function for transmitting an identifier to the terminal device with the schedule-related information.

Furthermore, the server may have a function for retrieving information relating to vacant time of the schedule data.

Additional objects, advantages and novel features of the embodiments will be set forth in part in the description which follows, and in part will become apparent to those skilled in the art upon examination of the following and the accompanying drawings or may be learned by production or operation of the embodiments. The objects and advantages of the inventive concepts may be realized and attained by means of the methodologies, instrumentalities and combinations particularly pointed out in the appended claims.

### BRIEF DESCRIPTION OF THE DRAWINGS

The drawing figures depict preferred embodiments by way of example, not by way of limitations. In the figures, like reference numerals refer to the same or similar elements.

FIG. 1 is an exemplary diagram for illustrating an embodiment of the present invention;

FIG. 2 is a diagram for illustrating an example of an inputted schedule table in the embodiment in FIG. 1;

FIG. 3 is an exemplary diagram for explaining a service information offering received from a server;

FIG. 4 is an exemplary diagram for showing a flow chart for the operation of a mobile information terminal device in FIG. 3;

FIG. 5 is a diagram for illustrating an information example obtained as the result of inputting the schedule table;

FIG. 6 is a diagram for illustrating an information example obtained as the result of inputting the schedule table;

FIG. 7 is an exemplary flow chart for inputting the schedule table;

FIG. 8 is a diagram for illustrating a schedule pack example based on inputted data;

FIG. 9 is a diagram for illustrating a pre-registered keyword example;

FIG. 10 is an exemplary flow chart for creating the schedule pack;

FIG. 11 is a diagram for illustrating a tag example used for the schedule pack;

FIG. 12 is an exemplary flow chart for transmitting the schedule pack to the service server;

FIG. 13 is a diagram for illustrating a configuration example of the service server;

FIG. 14 is an exemplary flow chart for the operation of the service server;

FIG. 15 is an exemplary flow chart for a service information retrieval by the service server;

FIG. 16 is a diagram for illustrating an item definition data example of an answer pack to be transmitted by the service server;

FIG. 17 is a diagram for illustrating an information data example of the answer pack to be transmitted by the service server;

FIG. 18 is a diagram for illustrating a tag example used for transmitting the answer pack;

FIG. 19 is an exemplary flow chart for transmitting the answer pack;

FIG. 20 is an exemplary diagram for explaining an information delivering system;

FIG. 21 is an exemplary flow chart for the operation of a mobile information terminal in FIG. 20;

FIG. 22 is an exemplary flow chart for the operation of a service server in FIG. 20;

FIG. 23 is an exemplary flow chart for the operation of an operating terminal of a business entity (i.e., advertising sponsor) in FIG. 20;

FIG. 24 is a diagram for illustrating an example of a display picture on which, on a calendar display of the schedule table, unit schedules and schedule-related WEB information are displayed in a state of being made related with each other;

FIG. 25 is a diagram for illustrating an example of a display picture on which, on a detailed display of the unit schedules, the unit schedules and the schedule-related WEB information are displayed in a state of being made related with each other;

FIG. 26 is an exemplary diagram for showing a flow chart for a mobile information terminal and a service server in a 3rd embodiment;

FIG. 27 is a diagram for illustrating an example of a display picture on the calendar display of the schedule table in the mobile information terminal in the 3rd embodiment;

FIG. 28 is a diagram for illustrating a display example of the detailed-picture of an advertisement of the schedule table in the mobile information terminal in the 3rd embodiment;

FIG. 29 is an exemplary diagram for showing a flow chart for a mobile information terminal and a service server in a 4th embodiment; and

FIG. 30 is an exemplary diagram for showing a flow chart for a mobile information terminal and a service server in a 5th embodiment.

### DETAILED DESCRIPTION OF THE EMBODIMENTS

Hereinafter, referring to the drawings, the explanation will be given below concerning the embodiments of the present invention.

In the explanation below, a PIM (Personal Information Manager) refers to a software program that an individual utilizes in a mobile information terminal device in order to manage the personal information, e.g., a schedule table, an address book, a working schedule table, and a memo. PIM data refers to the personal information managed by the PIM. A “schedule table” is a calendar file for writing the user's schedule data, like a datebook, a pocket diary, an appointment book and so on. Therefore, schedule data is referred to as calendar data. Also, service information refers to, e.g., the open/close times of a shop, the location of a scenic spot, the summary or the original of information such as news, and information including the link to a Web site where the information is available. Also, a unit of schedule refers to an entry in a schedule table configured by including at least any one of scheduled time, scheduled place, and scheduled content, respectively. Each unit of a schedule corresponds to each event, in other words, 1 unit of a schedule corresponds to 1 event, for example Mar. 3, 2001, 17:00-20:00(date and time)—meeting(contents)—in Sinjuku(place). Therefore, for example, a unit of schedule data is configured by combining at least any one of the scheduled times-and-dates, the scheduled contents, and the scheduled place, corresponding to an event. A “pack” is a generic term for a bundle of data grouped together for transmission. A “schedule pack” for example is a pack containing some or all of the data of a schedule table, or data derived there from and possibly other related data such as unit schedule ID.

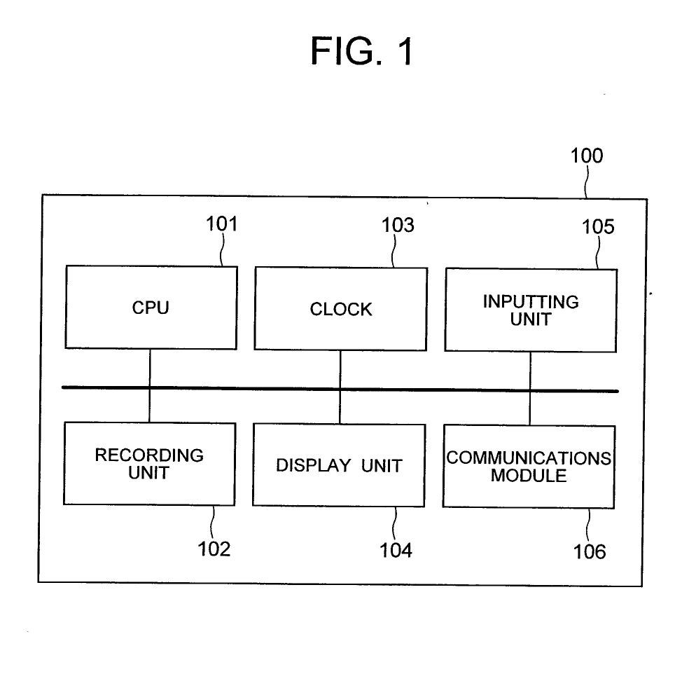

FIG. 1 is an exemplary diagram for illustrating an embodiment of the mobile information terminal device according to the present invention. In FIG. 1, the mobile information terminal device 100 includes the following configuration components: 101 a CPU (Central Processing Unit) for controlling devices, CPU 101 is referred to as controller, 102 a recording unit including a RAM (Random Access Memory), a ROM (Read Only Memory), a hard disk, or the like for storing the PIM (Personal Information Manager (i.e., the software that an individual utilizes in the mobile information terminal device in order to manage the personal information, e.g., the schedule table, the address book, the working schedule table, and the memo)), the PIM data (i.e., the personal information managed by the PIM), a control software, a communications software, and the like, recording unit 102 is referred to as a memory, 103 a clock for holding the date and the time, 104 a display unit such as an LCD (Liquid Crystal Display), 105 an inputting unit such as buttons or a touch panel used for performing inputting operations, e.g., inputting the PIM data, and watching/listening to the contents on a Web site, 106 a communications module for connecting the present mobile information terminal device to a network such as the Internet. For example, a communications module 106 may be equipped with a telephony port for transmitting and receiving speech data and e-mail over telephone circuits, or a Bluetooth port for transmitting and receiving data without using the telephone circuits (“Bluetooth” is a trademark). Communications module 106 may include transceiver or GPS receiver, and specifies a position and transmits specified position information to a server. The date and the time may also be held in the above-described recording unit.

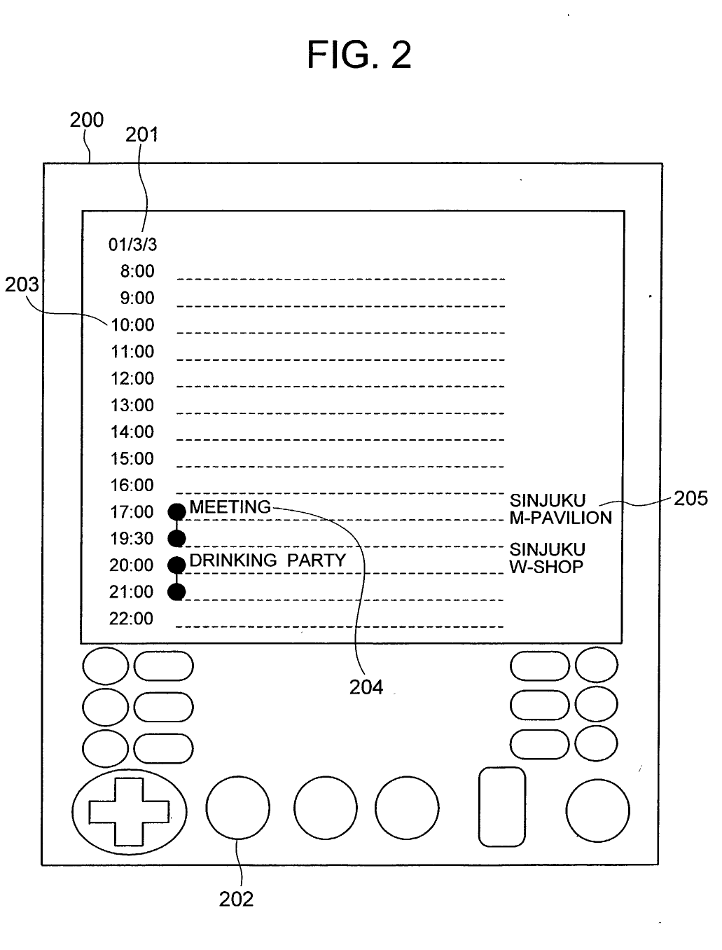

FIG. 2 illustrates an example of the PIM data, specially schedule data on a schedule table and a displayed example thereof.

In FIG. 2, the reference numerals denote the following: 200 the mobile information terminal device, 201 the LCD, 202 the inputting device, 203 scheduled times-and-dates, 204 scheduled contents, 205 scheduled places. In the present example, the mobile information terminal device 200 displays, on the LCD 201, a schedule table, i.e., one example of the PIM data. The scheduled times-and-dates 203 are displayed in association with the corresponding scheduled contents 204 and scheduled places 205, thereby being confirmed as the schedule table by the user. The user inputs and operates the schedule table through the inputting device 202.

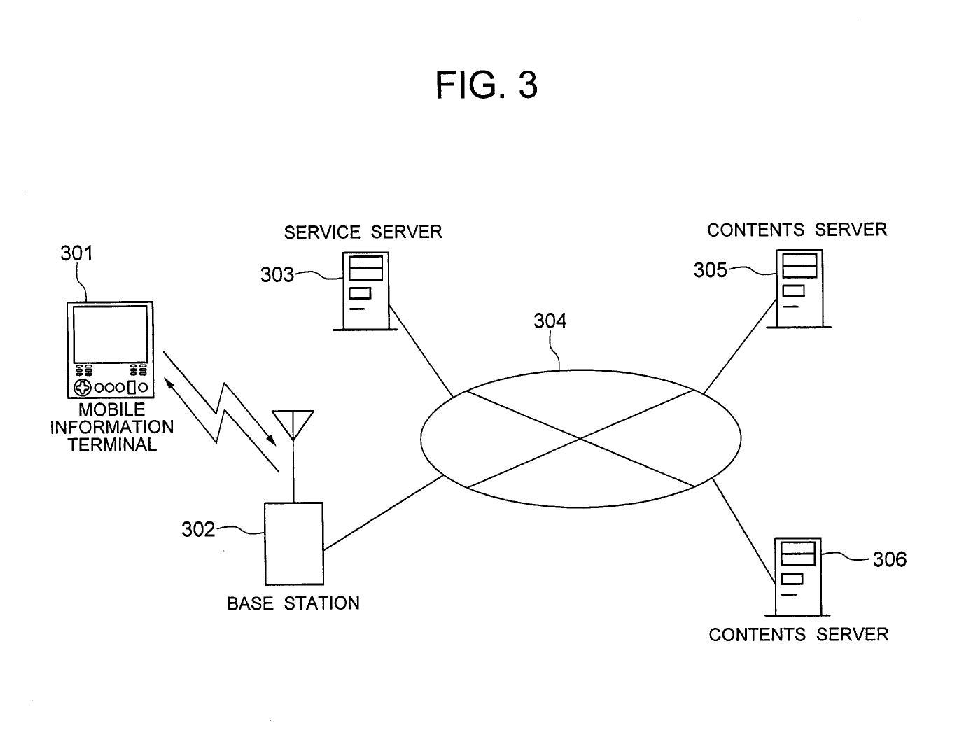

FIG. 3 is an example of explanatory diagram in the case where, based on the PIM data inputted as are illustrated in FIG. 2, the mobile information terminal device receives the offering of the service information from the service server via the network.

In FIG. 3, the reference numerals denote the following: 301 the mobile information terminal device, 302 a base station, 303 the service server, 304 the network, 305, 306 contents servers. The mobile information terminal device 301 is connected to the base station 302 with the use of a wireless line or a wired line. The base station 302 is connected to the network 304. The service server 303 and the contents servers 305, 306 are also connected to the network 304. The service server 303 is a server for providing the service information related with the PIM data from the mobile information terminal device 301. The contents servers 305, 306 correspond to what are referred to as “the Web sites” in general.

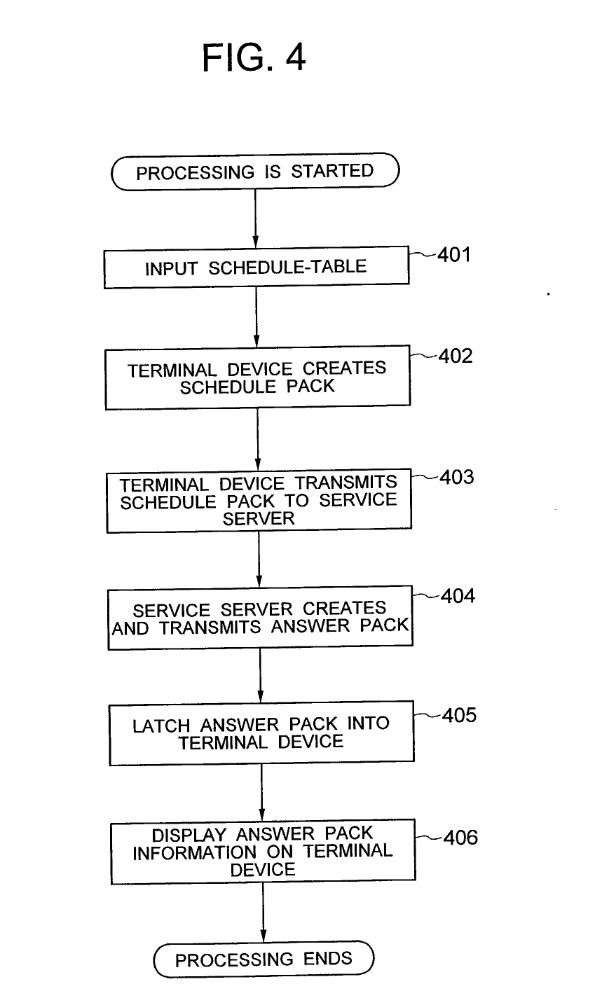

FIG. 4 shows a flow chart for the operation of the mobile information terminal device in FIG. 3.

In the flow chart in FIG. 4, when the processing is started, the user inputs a schedule table into the mobile information terminal device 301 (step 401). At the present step 401, the schedule table is inputted which includes at least any one of the scheduled times-and-dates, the scheduled contents, and the scheduled places. If the schedule table has been inputted, the mobile information terminal device 301 creates a schedule pack on the basis of the schedule table (step 402). If the schedule pack has been created, the mobile information terminal device 301 transmits the schedule pack to the service server 303 (step 403). Having received the transmitted schedule pack, the service server 303 creates an answer pack on the basis of the received schedule pack, then transmitting the answer pack (step 404). The mobile information terminal device 301 receives the transmitted answer pack. The received answer pack is latched into the mobile information terminal device 301 (step 405). The information based on the latched answer pack is displayed when the user uses the present mobile information terminal device 301 (step 406).

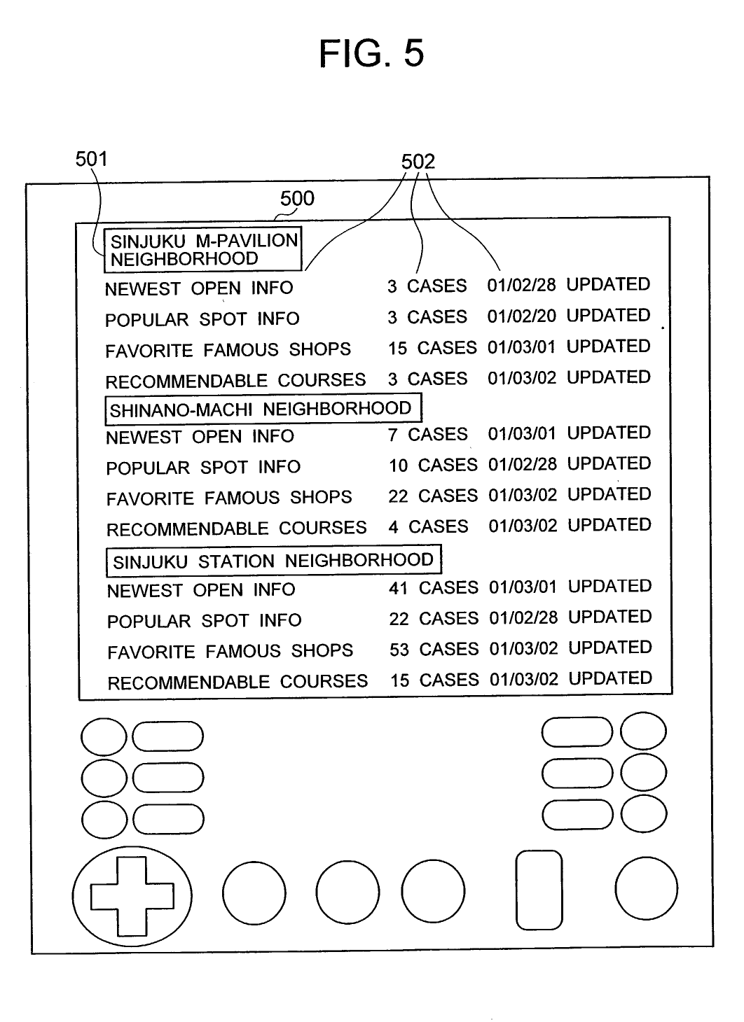

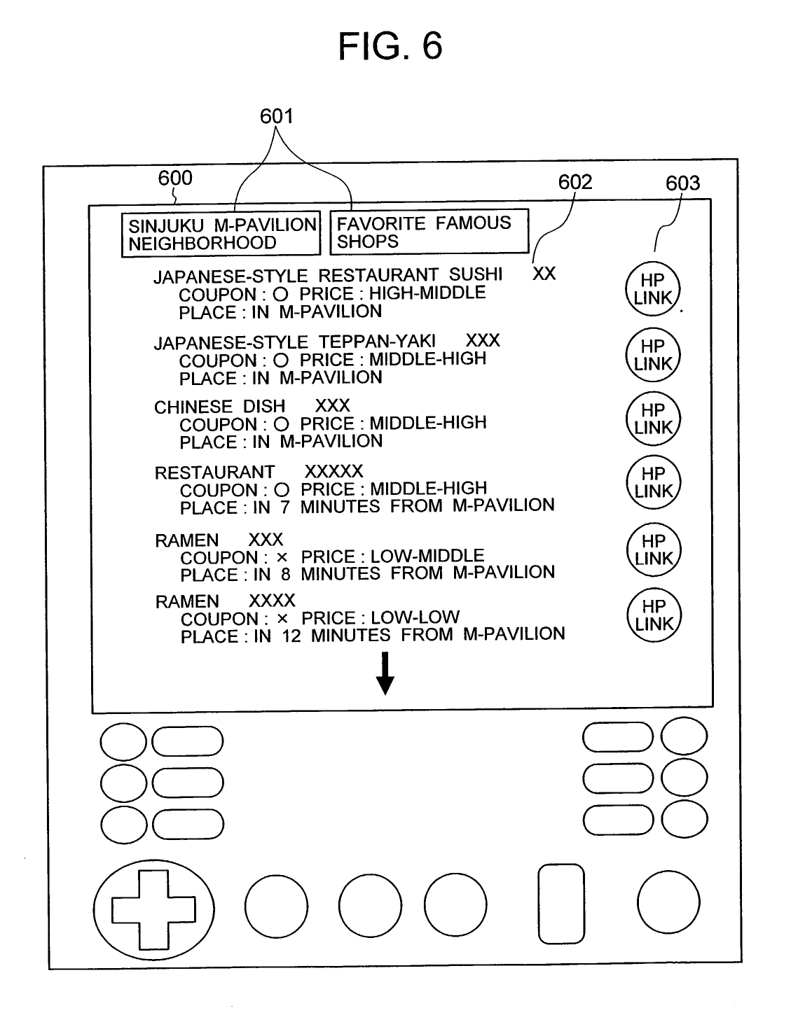

FIG. 5 and FIG. 6 illustrate displayed picture examples at the above-described step 406.

FIG. 5 illustrates a displayed example of the service information based on the schedule table.

In FIG. 5, the reference numerals denote the following: 500 the LCD, 501 the scheduled places, 502 information related with the scheduled times-and-dates 203 or the scheduled contents 204, or information related with the scheduled places 205 alone, and the number of the cases thereof and the updated information thereof. If the user has selected, e.g., “favorite famous shops”, the display on the LCD 500 transitions to the display in FIG. 6. Incidentally, it is assumed that the numerals 500 and 600 denote the same LCD. In FIG. 6, the numerals denote the following: 601 the items that the user has selected, 602 the outline of each information, 603 the link information on the corresponding Web sites. Selecting the numeral 603 makes it possible to display the corresponding Web sites. The pictures like this are displayed. This condition allows the user to make the service information related with the schedule table available to the user by a simplified operation and via the network.

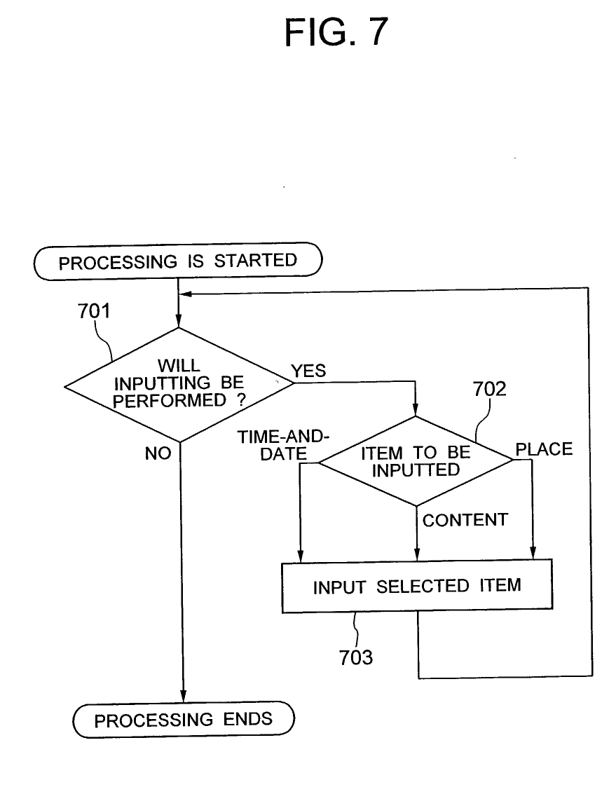

FIG. 7 is a flow chart for explaining the contents at the step 401 illustrated in FIG. 4.

In FIG. 7, when the processing is started, the mobile information terminal device 301 makes an inquiry of the user as to whether or not the user will input the schedule data (step 701). At the step 701, the mobile information terminal device may set up a condition, thereby judging whether or not to perform the inputting. If no inputting is performed, the processing is terminated. If the inputting is performed, the mobile information terminal requests the user to select as to which of the items the user will perform the inputting (step 702). At the step 702, the mobile information terminal device may set up a condition, and thereby the mobile information terminal itself may select an item to be inputted. Even if any one of the scheduled times-and-dates, the scheduled contents, and the scheduled places has been selected, the user performs the inputting concerning the contents of the selected item (step 703), and then the processing transfers to the step 701.

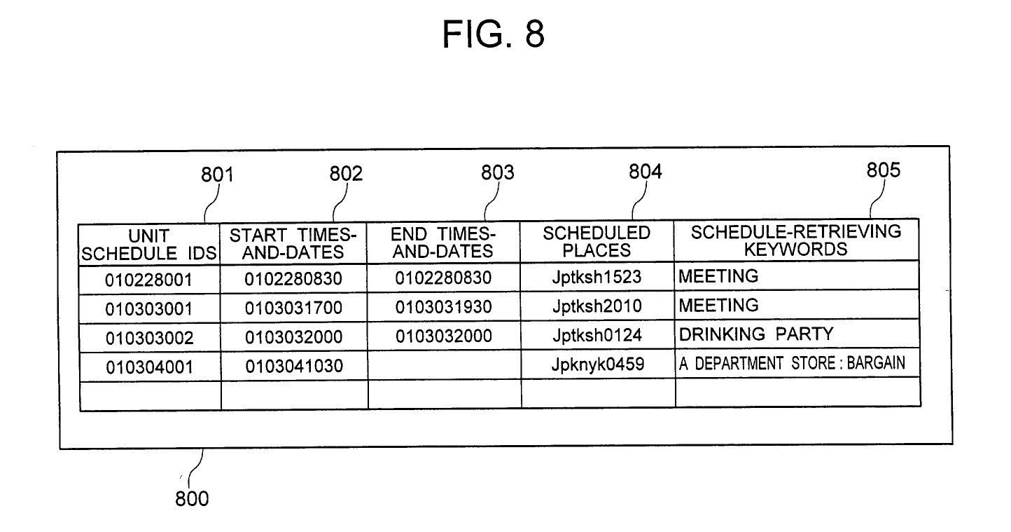

FIG. 8 shows an example of the schedule pack formed by the processing in FIG. 7 from the inputted schedule data so as to be transmitted to the service server.

In FIG. 8, the reference numerals denote the following: 800 a schedule table, 801 an item of unit schedule IDs, 802 an item of starting times-and-dates, 803 an item of ending times-and-dates, 804 an item of scheduled places, 805 an item of schedule-retrieving keywords. The schedule table 800 includes the 5 items ranging from 801 to 805. The unit schedule IDs 801, in FIG. 2, are IDs for specifying the unit schedules configured by combining at least any one of the scheduled times-and-dates 203, the scheduled contents 204, and the scheduled places 205. The starting times-and-dates 802 indicate the times-and-dates when the unit schedules will be started. Similarly, the ending times-and-dates 803 indicate the times-and-dates when the unit schedules will be ended. The scheduled places 804 indicate the places related with the unit schedules. Incidentally, using the table latched in the mobile information terminal device, the scheduled places in inputted character strings are converted into codes expressed by numerical values or characters such as alphanumeric characters, then being used as the scheduled places 804. Otherwise, the inputted character strings are directly used as the scheduled places 804 without being converted into the codes. The schedule-retrieving keywords 805 are created by the mobile information terminal device on the basis of the following: All of the scheduled contents 204, partial character strings extracted using a dictionary such as pre-registered keywords that will be described later, or the user's taste. The schedule-retrieving keywords 805 are used at the time of retrieving the service information. The case where the schedule-retrieving keywords 805 are used are classified into the one where the pre-registered keywords are used and the one where the character strings described in the scheduled contents are used without being converted into the codes.

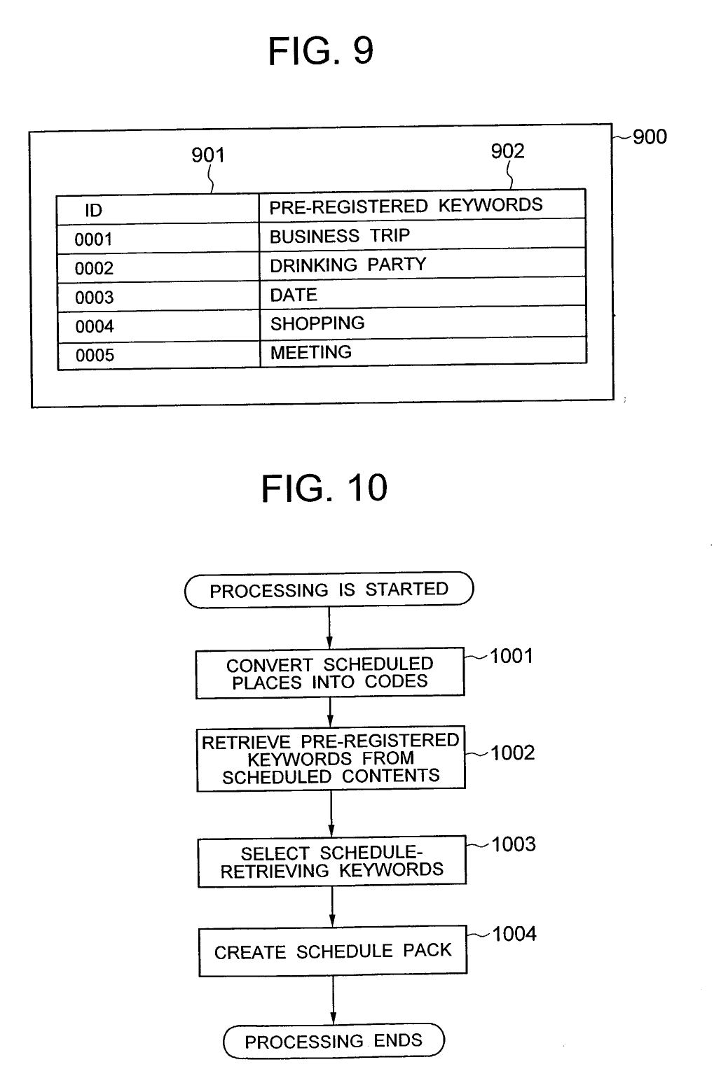

FIG. 9 is a diagram for explaining one example in the case where the pre-registered keywords are used.

In FIG. 9, the reference numerals denote the following: 900 the pre-registered keywords, 901 pre-registered keywords' IDs used for managing the pre-registered keywords, 902 the pre-registered keywords where the described character strings are character strings registered by the user, the mobile information terminal device, or the service server. When the mobile information terminal device creates the schedule-retrieving keywords, character strings that are the same as the pre-registered keywords are extracted from the character strings described in the scheduled contents. This makes it easier to automatically create the schedule-retrieving keywords that the user has intended.

FIG. 10 indicates the flow of an operation for creating the schedule pack 800 with the use of the above-described pre-registered keywords 900 and the schedule data inputted by the user.

In FIG. 10, when the processing is started, based on a place dictionary having the scheduled places built therein (i.e., a conversion table where the names of places, locations, and scenic spots have been encoded), the mobile information terminal device performs the code conversion (step 1001). Also, the entire place dictionary need not be latched within the mobile information terminal device, but may be downloaded as required via the network. Also, when the character strings in the scheduled places are used directly or used “as they are” as the scheduled places 804 in the schedule pack, the step 1001 may be skipped. Next, the pre-registered keywords are retrieved from the scheduled contents inputted by the user (step 1002). At the step 1002, the use of the pre-registered keywords as a dictionary makes it possible to extract, by a simplified operation, words such as nouns that are appropriate as the retrieving keywords. Also, words that the user does not wish to use as the retrieving keywords are not registered as the pre-registered keywords. This makes it possible to reflect the user's intention of not wishing the retrieval, and also results in an effect of prohibiting the unnecessary information from leaking to the outside of the mobile information terminal device. Next, the words retrieved at the step 1002 are selected as the schedule-retrieving keywords (step 1003). At this time, in addition to the words retrieved at the step 1002, a word expressing the user's taste may be selected. As the next step, the schedule pack is created from the unit schedule IDs, the starting times-and-dates, the ending times-and-dates, the scheduled places, and the schedule-retrieving keywords (step 1004). The processing is ended here.

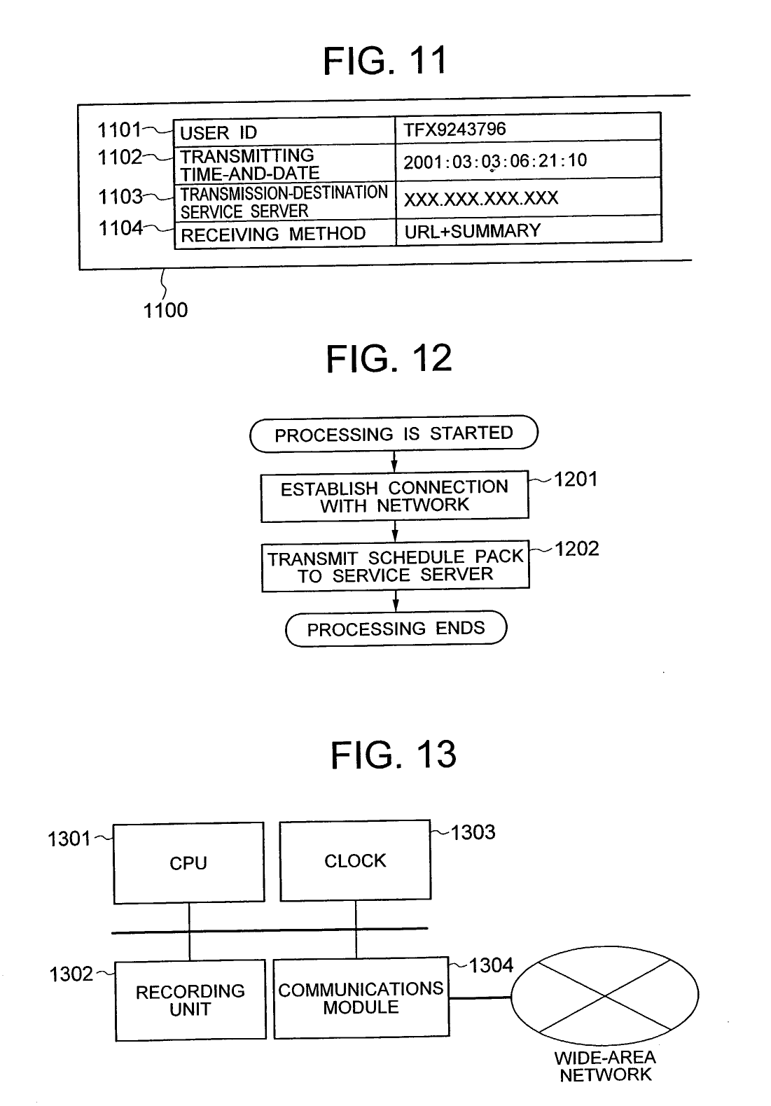

FIG. 11 is an exemplary diagram for explaining a tag 1100 used and added when transmitting the schedule pack from the mobile information terminal device 301 to the service server 303.

In FIG. 11, the tag 1100 includes a user ID 1101, a transmitting time-and-date 802, a transmitted-destination service server 803, and a receiving method 1104. The user ID 1101 is for explicitly indicating the owner of the present schedule pack. The transmitting time-and-dates 1102 is for recording the time-and-date when the present schedule pack has been transmitted. The transmitting time-and-date is used as a judging condition at the time when, on the service server 303 side, the schedule pack is discarded if the arrival of the schedule pack at the service server is delayed from the starting time-and-date 1102 or the ending time-and-date 1103 for the conveniences of the network or the server. The transmitted-destination service server 1103, which is an address, an ID, or the like for specifying a service server that the user has intended as the transmitted-destination of the schedule pack, is used in the case of avoiding an erroneous delivery or the like. The receiving method 1104, which describes a receiving method on the mobile information terminal device side for receiving the answer pack that will be explained later, specifies the receiving method to be, e.g., “URL+summary”.

FIG. 12 is a flow chart for indicating the processing steps in the case where, based on the tag 1100, the mobile information terminal device 301 transmits the schedule pack to the service server 303.

In FIG. 12, the mobile information terminal device 301 establishes the connection with the base station 302 or the like, thereby being connected to the network 304 (step 1201). Having been connected to the network, the mobile information terminal device 301 transmits the schedule pack to the service server 303 (step 1202). As the method for transmitting the schedule pack at the step 1202, an electronic mail or communications utilizing a file transferring protocol can be considered.

FIG. 13 illustrates an embodiment of the service server 1300 for receiving the schedule pack so as to return the answer pack, illustrating a configuration example of the hardware.

In FIG. 13, the reference numerals denote the following: 1301 a CPU for providing the services by the service server through the controls of the respective units, CPU 1301 is referred to as controller, 1302 a recording unit such as a RAM, a ROM, and a hard disk for recording the data needed for creating the answer pack and a control software or a communications software of the service server, recording unit 1302 is referred to as a storage device, 1303 a clock for holding the date and the time, 1304 a communications module for providing a module needed for connecting the present service server to the network such as the Internet. The date and the time may also be held in the RAM/ROM.

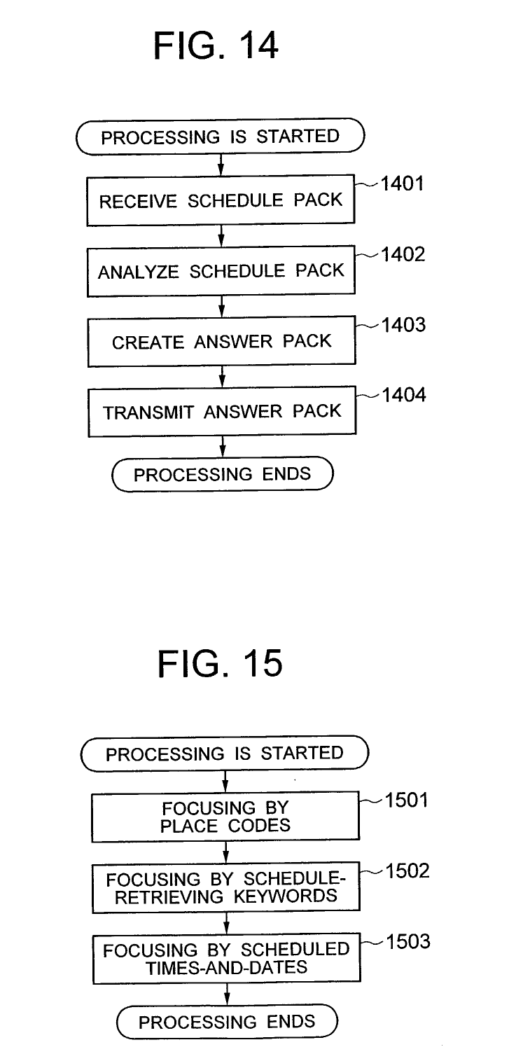

FIG. 14 is a flow chart for explaining the data processing steps at the time when the service server 303 receives the schedule pack.

In FIG. 14, on receiving the schedule pack (step 1401), the service server 303 analyzes the schedule pack (step 1402). The step 1402 includes a working operation of decrypting the encrypted schedule pack, a working operation of converting the character strings or the codes in the schedule pack into internal-codes of the service server, and the like. After analyzing the schedule pack, the service server creates the answer pack (step 1403). In this time, the service server may create a summary based on the data stored in the recording unit 1302 if a summary is not already stored in the recording unit 1302. The answer pack is data needed to display the information as illustrated in FIG. 5 and FIG. 6. Next, the server transmits the answer pack (step 1404). The recording unit 1302 may stores a dictionary of the keyword, and the CPU 1301 may references the dictionary to extract a word found in the dictionary from the schedule pack for use as a schedule-searching keyword, and The CPU 1301 retrieves schedule-related information by using the schedule-searching keyword.

FIG. 15 is an explanatory diagram for explaining a service information focusing-retrieval processing that is performed when creating the answer pack. When the processing is started, at first, the area of retrieval or search is focused or narrowed by the place codes (step 1501). At the step 1501, the focusing is performed by the product of the place codes and place codes of the service information on the service server. Next, the service information is focused using the schedule-retrieving keywords (step 1502). Still next, the service information is focused by the scheduled times-and-dates (step 1503). The order of the step 1501 to the step 1503 may be exchanged. Also, any one of the steps 1501 to 1503 may be omitted. Also, if the retrievals by the place codes and the times-and-dates are impossible in the focusing of the service information, the place codes may be converted into the place names so as to be added to the schedule-retrieving keywords. Also, the times-and-dates may be added to the schedule-retrieving keywords.

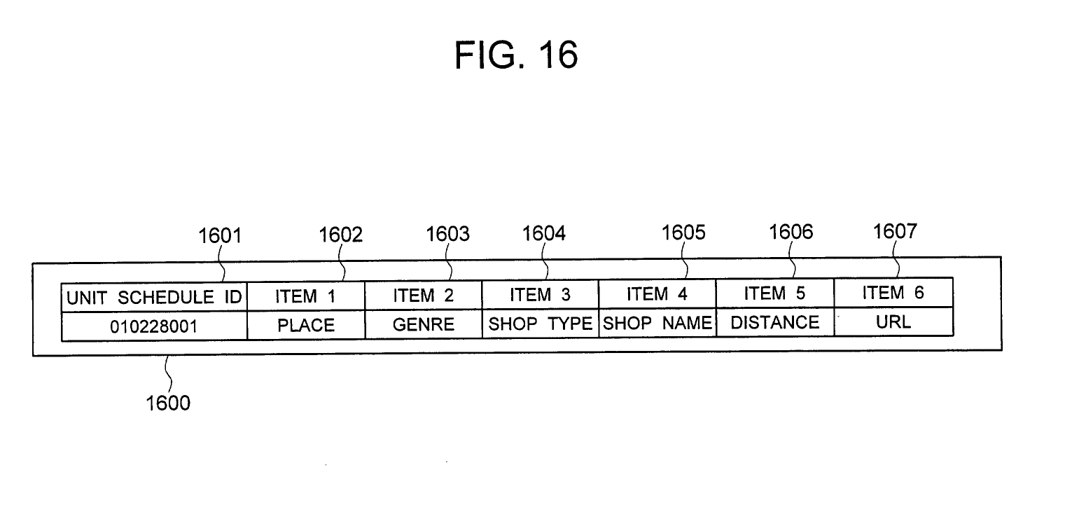

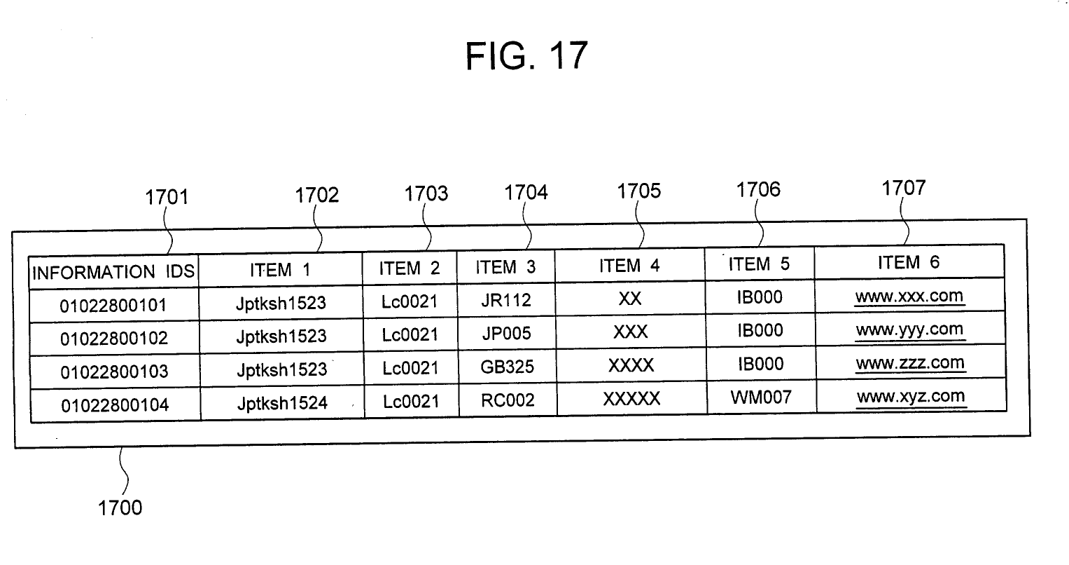

FIG. 16 and FIG. 17 are exemplary diagrams for explaining the configuration of the answer pack. The answer pack includes item defining data 1600 and information data 1700. The item defining data 1600 is used for defining the meanings of items in the case of dividing the service information into the items. The information data 1700 includes information IDs and the processed service information. In the present example, there exists 6 items, and the items 1 to 6 correspond to 1602 to 1607 each. A unit schedule ID 1601 corresponds to the unit schedule IDs 801 in the schedule pack 800. The service information includes the item 1 (1602) to the item 6 (1607), and the meanings of the respective items are described in the data 1600. A numeral 1701 denotes information IDs, which are obtained by adding numerical-value strings to the unit schedule ID. The information IDs are IDs inside the mobile information terminal, and may be created by a method other than the creating method of 1701 as long as the information IDs are IDs that make it possible to infer the unit schedule ID by analogy. Also, the data of the respective items are described in items 1702 to 1707 in the data 1700.

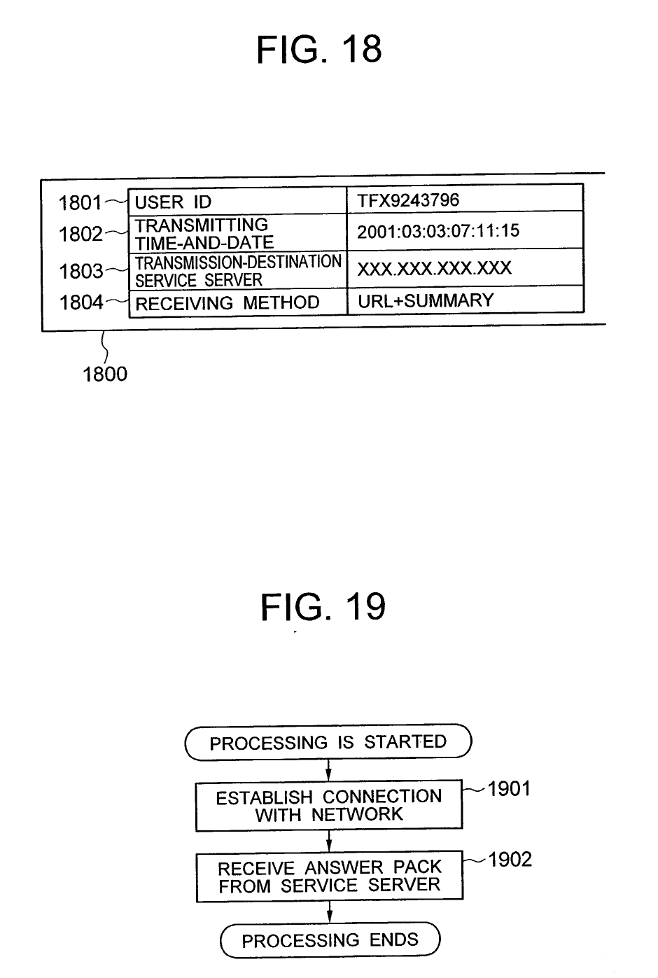

FIG. 18 is an exemplary diagram for explaining a tag 1800 used and added when transmitting the answer pack from the service server 303 to the mobile information terminal device 301. The tag 1800 includes a user ID 1801, a transmitting time-and-date 1802, a transmitting-source service server 1803, and a receiving method 1804. The user ID 1801 is for explicitly indicating the returned-destination of the present answer pack. The transmitting time-and-date 1802 is for recording the time-and-date when the present answer pack has been returned. The transmitting time-and-date is used as a judging condition at the time when, on the mobile information terminal device 301 side, the answer pack is discarded if the arrival of the answer pack at the mobile information terminal device 301 is delayed from the starting time-and-date 802 or the ending time-and-date 803 for the conveniences of the network or the server. The transmitting-source service server 1803, which is an address, an ID, or the like for specifying the service server that is the transmitting-source of the answer pack, is used in the case of avoiding an erroneous delivery. The receiving method 1804 describes a method for describing the answer pack.

FIG. 19 is a flow chart for indicating the processing steps in the case where, based on the above-described tag 1800, the service server 303 transmits the answer pack to the mobile information terminal device 301. The service server 303 is connected to the network 304 (step 1901). Having been connected to the network, the service server 303 transmits the answer pack to the mobile information terminal device 301 (step 1902). As the method for transmitting the answer pack at this step 1902, an electronic mail or communications utilizing a file transferring protocol can be considered.

In the above-described embodiment, the service server 303 includes a charge-billing unit for calculating a charge for the offering of the service information toward the mobile information terminal device 301 and outputting the charge as charge-billing information. The charge-billing information are as follows: Information on an information providing charge toward the mobile information terminal device 301, information on an information providing charge such as an advertisement charge toward a business entity or the like (or the terminal of the business entity or the like) in the case where the service server 303 receives an information-providing request such as an advertisement request or the like from the business entity or the like (or the terminal of the business entity or the like) and transmits the answer pack to which beneficial information such as advertisement information has been added, and the like.

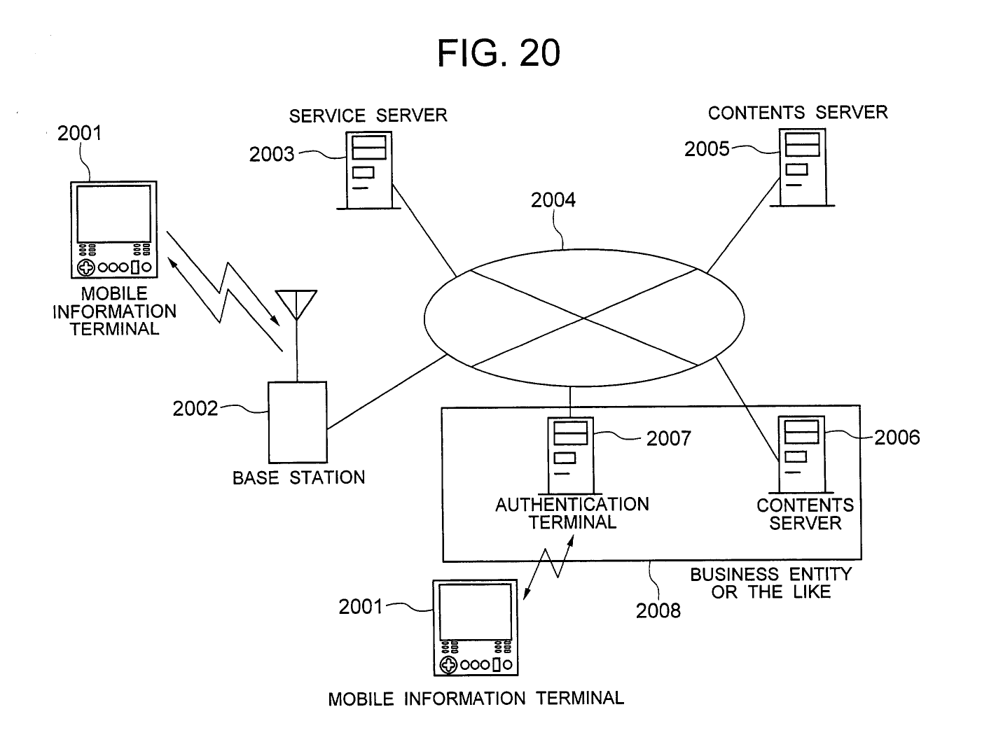

FIGS. 20 to 23 are explanatory diagrams in the case where the charge-billing is performed toward the above-described business entity or the like (or the terminal of the business entity or the like).

FIG. 20 is an exemplary diagram for explaining an information delivering system employing the present mobile information terminal device, the contents servers, and the service server. The reference numerals 2001 to 2006 denote the same configuration components as those in FIG. 3. The mobile information terminal device 2001 is connected to the base station 2002 with the use of the wireless line or the wired line. The base station 2002 is connectable to the network 2004. The service server 2003 and the contents servers 2005, 2006 are also connected to the network 2004. A numeral 2007 denotes an authentication terminal that is connectable to the network 2004. The authentication terminal 2007 is also made connectable to the mobile information terminal device 2001 via a wireless line or a wired line. A business entity or the like 2008 is assumed to own a usage right of the contents server 2006 and that of the authentication terminal 2007. The business entity or the like 2008, using a personal computer terminal, the mobile information terminal, or the like, provides the advertisement information such as commodity information to the contents server 2006.

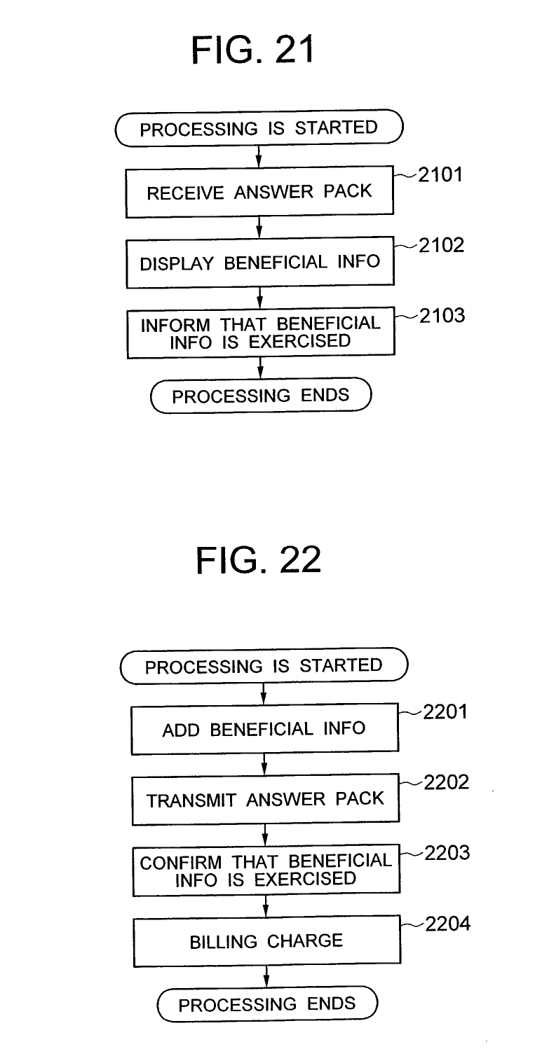

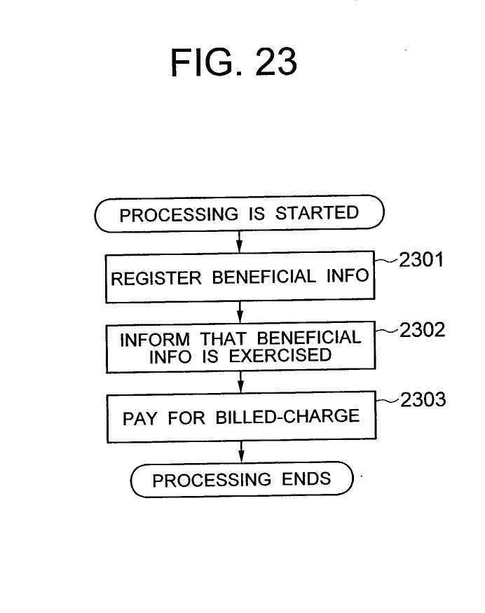

FIG. 21, FIG. 22, and FIG. 23 are flow charts for the operation outline of the information delivering system employing the present mobile information terminal device, the contents servers, and the service server. FIG. 21 shows the operation outline of the mobile information terminal device 2001. FIG. 22 shows the operation outline of the service server 2003. FIG. 23 shows the operation outline of the operating terminal of the business entity or the like 2008.

In FIGS. 20 to 23, the business entity or the like 2008, using the personal computer terminal, the mobile information terminal, or the like, registers the advertisement information into the service server 2003 (step 2301). At the step 404 (FIG. 4) where the service server creates and transmits the answer pack, the service server 2003 adds, to the answer pack, the beneficial information such as the advertisement information by the business entity or the like 2008 (step 2201). As the beneficial information such as the advertisement information by the business entity or the like 2008, in addition to the commodity information or the like, the information, e.g., a coupon ticket or a service ticket that is usable for the business entity or the like 2008, is also included. The service server 2003 transmits the beneficial information-added answer pack to the mobile information terminal device 2001 (step 2202). The mobile information terminal device 2001 receives the answer pack (step 2101), then displaying the beneficial information such as the advertisement information as well (step 2102). When the above-described beneficial information is the coupon ticket or the service ticket and if the beneficial information has been exercised, the mobile information terminal device 2001 informs the authentication terminal 2007 or the base station 2002 that the beneficial information has been exercised (step 2103). At the same step, the authentication terminal 2007 or the base station 2002 informs the service server 2003 that the beneficial information by the business entity or the like 2008 has been exercised (step 2302). The service server 2003 confirms that the beneficial information has been exercised (step 2203). The service server 2003 calculates a charge for the transmission of the beneficial information so as to create and store the charge as charge-billing information, then transmitting the charge-billing information to the terminal of the business entity (i.e., advertising sponsor) or the like 2008 at a predetermined time-period. Based on the charge-billing information from the service server 2003, the business entity or the like 2008 pays for the information providing charge to a delivering business entity or the like that performs the information delivery at the service server (step 2303). Incidentally, as the charge-billing information, the service server may create and transmit both the charge-billing information to the business entity or the like 2008 or the operating terminal thereof and the charge-billing information to the mobile information terminal or the user thereof that receives the service information. In that case, depending on the number of the receptions of the service information to which the beneficial information such as the advertisement information has been added, the billed-charge amount toward the mobile information terminal or the user thereof may be discounted.

According to the above-described embodiment, (1) the operator can obtain the schedule-related information by the simplified operation, and can know the information-obtained source as well. (2) From a part of the inputted schedule table, the schedule table-related service information can be obtained. (3) The mobile information terminal device can obtain the necessary information and the service information related with the schedule table in a suitable format for the mobile information terminal. (4) The time and the labor required for the operator to input the position information can be reduced, and the accurate position information can be transmitted. (5) The mobile information terminal device can confirm the identity between the unit schedule to be transmitted and the service information based on the unit schedule to be received. (6) With a timing that does not interfere with the operation by the operator, the schedule table can be transmitted automatically. (7) At a time that the operator wishes, the schedule table can be transmitted automatically. (8) Another appliance connected to the network can also receive the service information by the transmission of the schedule pack. (9) The scheduled place-related service information can be selected. (10) The service information that is highly geographically related with the operator of the mobile information terminal device can be selected. (11) The service information that is highly related with the operator of the mobile information terminal device and the schedule can be selected. (12) The operator can confirm the retrieval result of the service information in a brief manner. (13) The operator can receive the schedule-related service, and the service provider such as the manager of the service server can provide the best-fitted service. (14) The beneficial information on the advertisement and the discount from the business entity or the like can be received along with the schedule pack. Also, (15) the discount of the billed-charge for the schedule-related service information can be received.

Incidentally, in the above-described embodiment, there exist the following: (1) a mobile information terminal device including a unit for specifying a word included in scheduled time-and-date data, scheduled place data, or scheduled content data so as to store the word as a registered keyword, and for transmitting the word to the server on the network, wherein the unit detects the lapse of a time set up from after the input completion of a unit schedule and, by the detection, transmits a pack of the schedule data including the unit schedule to the server on the network, (2) a mobile information terminal device including a unit for specifying a word included in scheduled time-and-date data, scheduled place data, or scheduled content data so as to store the word as a registered keyword, and for transmitting the word to the server on the network, wherein the unit makes reference to a set-up time-and-date of the transmission of a schedule data pack, the set-up time-and-date having been latched in the mobile information terminal device itself or the server on the network, and transmits the schedule data pack to the server on the network on the set-up time-and-date, (3) a server whose retrieving unit includes a unit for making a comparison with the service information by using at least any one of scheduled time-and-date data, scheduled place data, and a schedule-retrieving keyword included in a pack of schedule data, and for selecting service information that coincides therewith, (4) a server whose retrieving unit includes a unit for selecting service information in a scheduled place included in a pack of schedule data or its peripheral place, (5) a server whose retrieving unit includes a unit for selecting service information on a route on a map, on a route along which transportation facilities move, or their peripheral places, the route connecting a plurality of scheduled places included in a pack of schedule data, (6) a server whose retrieving unit includes a unit for making reference to personal information on an operator of the mobile information terminal device and a unit for adding the personal information to a schedule-retrieving keyword in a pack of received schedule data, (7) a server wherein a retrieving unit outputs the URL of a Web site to the above-described transmitting unit side as the retrieval result of the service information, and the transmitting unit transmits the URL, the URL coinciding with any one of a scheduled time-and-date, a scheduled place, or a schedule-retrieving keyword included in a pack of received schedule data, and the like.

Next, the explanation will be given below concerning a 2nd embodiment. The 2nd embodiment is substantially the same as the above-described 1st embodiment. The point that differs basically is a point that, on the picture of the schedule table, the mobile information terminal stores and displays the transmitted schedule data and the received service information in a state of being made related with each other.

At first, the user inputs a schedule into the schedule table of the mobile information terminal. As is the case with the 1 st embodiment, the mobile information terminal creates a schedule pack. As having been illustrated in FIG. 8, this schedule pack includes the unit schedule IDs, i.e., the IDs for identifying the unit schedules. The mobile information terminal transmits the created schedule pack to the service server. The service server receives this schedule pack, and temporarily stores, into the recording unit 1302, the unit schedule IDs included in this received schedule pack. The service server retrieves WEB information or the like which is related with the unit schedule data included in the received schedule pack. The WEB information includes the data or the like existing on the Web sites connected to the Internet and the data existing on all the forms of servers that provide information in response to the accesses. Also, the configuration of these Web sites and servers on the network may be equivalent to the component 305 in FIG. 3. The service server allocates each of information IDs to each of the retrieved schedule-related WEB information. The information IDs are IDs derived from the unit schedule IDs, and each of the information IDs is allocated to each of the plural pieces of schedule-related WEB information included in the retrieval result. The service server may add the beneficial information such as the coupon ticket to this retrieval result. The service server transmits, as an answer pack, the unit schedule IDs, the information IDs, and the retrieval result to the mobile information terminal. Having received this answer pack, the mobile information terminal stores, into the recording unit 102, the unit schedules and the schedule-related WEB information in a state of being made related with each other, using the unit schedule IDs and the information IDs. When displaying the unit schedules, the mobile information terminal displays the unit schedules in association with the corresponding schedule-related WEB information. Also, the configuration of the service server on the network may be equivalent to the component 303 in FIG. 3.

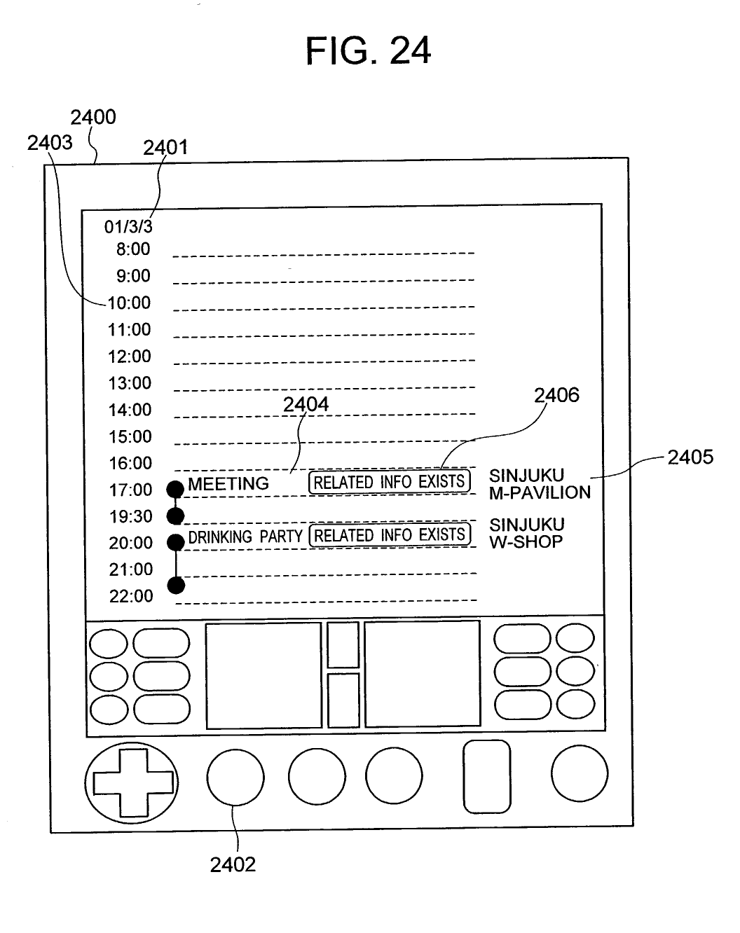

FIG. 24 illustrates an example of a display picture on which, on a calendar display of the schedule table, the unit schedules and the schedule-related WEB information are displayed in a state of being made related with each other. In FIG. 24, numerals 2400 to 2405 correspond to the numerals 200 to 205 in FIG. 2. A numeral 2406 indicates that the unit schedule to which the numeral 2406 is added is accompanied by the schedule-related WEB information.

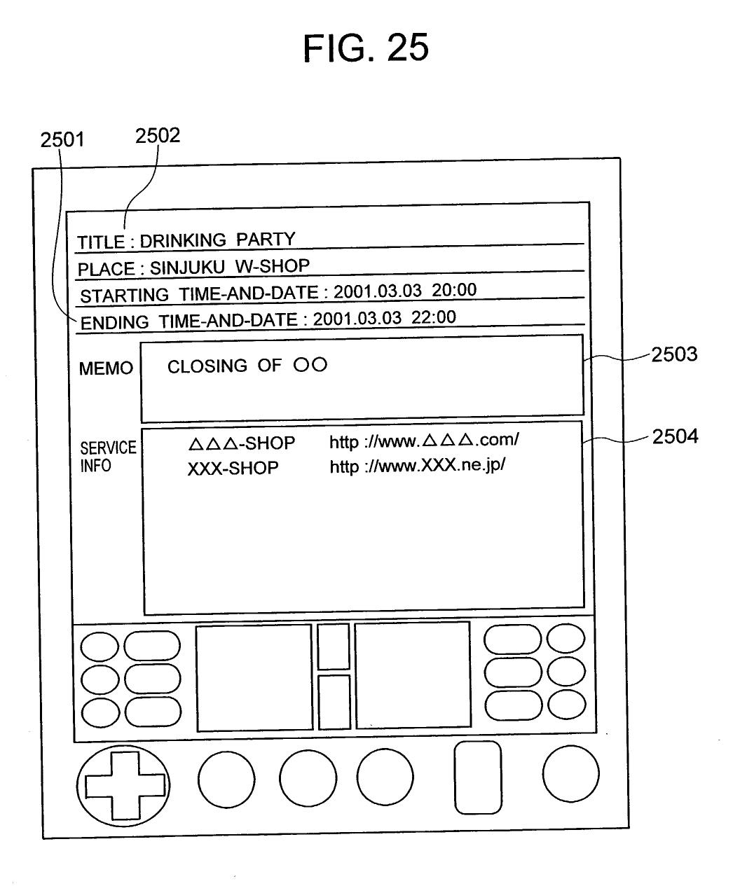

FIG. 25 illustrates an example of a display picture on which, on a detailed display of the unit schedules, the unit schedules and the schedule-related WEB information are displayed in a state of being made related with each other. The reference numerals correspond to the following, respectively: 2501 the scheduled times-and-dates, 2502 the scheduled place, 2503 the scheduled contents. These are data that the user had inputted in advance. A numeral 2504 denotes service information received from the service server. Although, in this example, the explanation has been given by taking the example where the displaying field for the service information is provided independently, the displaying method is not limited thereto, and it suffices if the unit schedules and corresponding service information are displayed in association with each other. For example, the method is allowable where the service information is subsequently added into the scheduled contents denoted by the numeral 2503.

Incidentally, although, in the explanation given so far, the explanation has been given such that the unit schedule data included in the schedule table data is transmitted to the service server, the transmitting method is not limited thereto. For example, it is also well enough to transmit the schedule table data instead of the unit schedule data that has been transmitted on each unit-schedule basis. In this case, the service server performs the above-described processing concerning each of the unit schedule data included in the schedule table data.

Also, in the explanation given so far, the explanation has been given such that the unit schedule IDs or the information IDs are used as the information for making the unit schedule data and the corresponding schedule-related information associate with each other, the relating method is not limited thereto. For example, the employment of the IP address and the transmitting time of the mobile information terminal allows the unit schedule data and the corresponding schedule-related information to be associated with each other as is the case with the explanation given so far. Also, the unit schedule data used for the retrieval is returned together with the schedule-related information, which also permits the unit schedule data and the corresponding schedule-related information to be associated with each other. Whatever method is allowable as long as it can make both of them associated with each other.

According to the 2nd embodiment explained so far, when the user confirms the user's schedule by the schedule table of the mobile information terminal, the user can easily obtain the WEB information related with that schedule. Also, the WEB manager who runs server for providing the WEB-information can perform the advertising activity of the WEB toward the user with a best-fitted timing synchronized with the user's schedule. Since the link can be set up in the schedule table, its advertising effect becomes exceedingly influential. Also, the service provider who runs the service server mediates between the user and the WEB manager, thus providing the user's schedule-related WEB information to the user and supporting the WEB manager to perform the WEB-advertising activity with the best-fitted timing synchronized with the user's schedule. This makes it possible to provide the service that is charming for both the user and the WEB manager. The service provider collects the information providing charge from the user, and collects a WEB-advertising activity supporting charge from the WEB manager. Otherwise, it is also advisable to collect only the WEB-advertising activity supporting charge without collecting the information providing charge from the user. This allows the service provider to make a profit.

Next, the explanation will be given below concerning a 3rd embodiment. The 3rd embodiment is an embodiment resulting from improving the 2nd embodiment one more step. The point that differs basically is a point that an appropriate advertisement is inserted into the portion of a vacant time in the schedule table of the user.

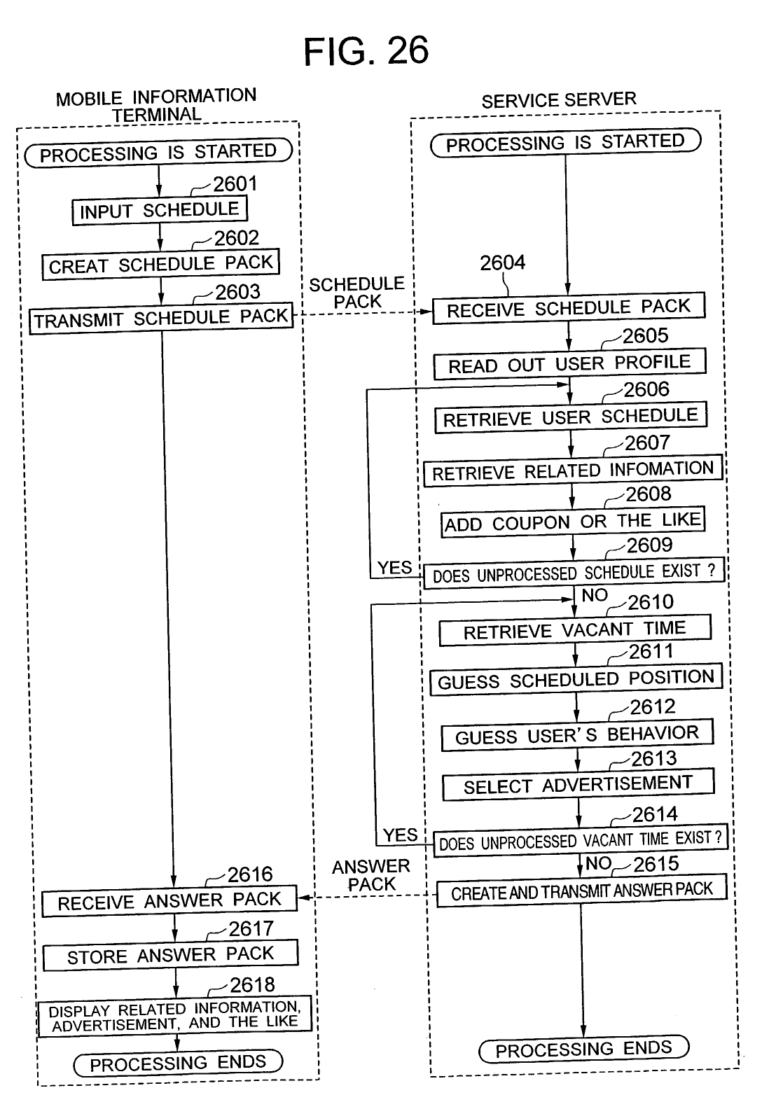

FIG. 26 is a diagram for showing a flow chart for the mobile information terminal and the service server in the 3rd embodiment.

At first, at a step 2601, the user inputs a schedule into the schedule table of the mobile information terminal. At a step 2602, the mobile information terminal creates a schedule pack with the use of the inputted schedule. Although this schedule pack includes a plurality of unit schedules, it is advisable to determine in advance the time-period of the unit schedules to be included in the schedule pack, for example, the unit schedules up until 2 weeks from today, or the like. In this case, the mobile information terminal creates the schedule pack with the use of the unit schedules up until 2 weeks from today. Of course, it is allowable to create the schedule pack with the use of all the unit schedules. At a step 2603, the mobile information terminal transmits the created schedule pack to the service server.

At a step 2604, the service server receives the schedule pack. At a step 2605, the service server reads out a user profile. The user profile has been stored in advance in the recording unit 1302 (FIG. 13) in the service server. Otherwise, it is also allowable to set up a database independently of the service server and to make the database store the user profile. The user profile includes information on the user's taste, the history of the past schedules, and the like.

At steps 2606 to 2609, the service server performs the following processing toward portions where the schedule exists within the schedule table of the user (i.e., the portions into which the user has inputted the schedule). At the step 2606, the service server specifies the first one unit schedule out of the plurality of unit schedules included in the received schedule pack. At the step 2607, as is the case with the 2nd embodiment, the service server retrieves WEB information related with the specified unit schedule. At the step 2608, the service server adds the beneficial information such as the coupon ticket to the retrieval result. At the step 2609, the service server judges whether or not an unprocessed unit schedule exists in the received schedule pack. If the unprocessed unit schedule exists, the processing goes back to the step 2606, then repeating the processing toward the unit schedule. If the unprocessed unit schedule does not exist, the processing goes to a step 2610.

At the step 2610 and steps 2611 to 2614, the service server performs the following proccssings toward portions where no schedule exists within the schedule table of the user (i.e., the portions into which the user has not inputted the schedule, namely, vacant times). At the step 2610, the service server specifies the first one vacant time out of the vacant times included in the schedule pack. This means that, within the time-period (e.g., up until 2 weeks from today) of the unit schedules to be included in the schedule pack, the server retrieves the portions into which the user has not inputted the schedule, thereby specifying the one portion.

At the step 2611, the service server guesses or presumes a place (i.e., guessed place) where there is a high possibility that the user exists during the vacant time. If schedules exist before and after the vacant time, the server guesses the guessed place from the schedules. If, for example, the scheduled places before and after the vacant time are the same scheduled place, the user is guessed to exist in the scheduled place during the vacant time therebetween. Also, if a schedule exists only in either before or after the vacant time, the user may be guessed to exist in the scheduled place similarly. If the schedules before and after the vacant time have been not inputted, it is allowable to guess the guessed place with the use of the user profile. For example, based on the information on the user's address or working place, the location or its peripheral area may be guessed as the guessed place. Also, based on the user's behavior history included in the user profile, a place that the user visits frequently or a place where the user existed the previous day or last week may be guessed as the guessed place.

At the step 2612, the service server guesses the user's behavior, thereby guessing what is the information that the user wishes. This is the information that the service server uses when selecting an advertisement at the step 2613. Concretely, in harmony with the user's taste judged from the user profile, it is possible to guess the information that the user will wish during the vacant time. For example, the information are as follows: Information on the movies for a user who likes the movies, information on the peripheral coffee shops for a user who often relax at a coffee shop, and information on a new publication or information on the peripheral book stores for a user who likes books. Also, conversely, the guessing is made concerning the information that the user will not wish. For example, if meal schedules exist before and after the vacant time, it can be guessed that the user is less likely to wish information on the meal during the vacant time. Otherwise, if a lunch schedule has been not inputted although the vacant time is lunchtime and meal schedules do not exist before and after the vacant time, either, it can be guessed that the user will probably eat lunch during the vacant time. Also, for example, if the scheduled places before and after the vacant time are different and the vacant time and the time needed to move between the two places are close, it can be guessed that the user is moving all the way during the vacant time. Accordingly, the user can be guessed to wish information on the movement, or information on a behavior that is executable while moving, e.g., traffic information, the WEB information that can be browsed while moving by the mobile information terminal.

At the step 2613, the service server selects an advertisement to be inserted into the vacant time. Concretely, using the vacant time specified at the step 2610, the guessed place guessed at the step 2611, and the user's guessed behavior guessed at the step 2612, the service server selects the advertisement that is fitted to the time, the place, and the behavior. For example, the selection area of advertisements can be focused or narrowed by the time-zone first, and then can be focused or narrowed by the place and the behavior. The focusing by the time-zone means that, concerning information on, for example, an event or the like whose time-zone is important, an advertisement that is unusable during the time-zone is excluded from the target of the selection. The focusing by the place means that, for example, an advertisement that is unusable in the guessed place is excluded from the target of the selection. The focusing by the behavior means that, for example, an advertisement that matches the guessed behavior is selected.

Here, if there exist a large number of advertisements selected, the selection range is made narrower so that the number becomes a suitable number (which may be set up in advance by the user, or may be set up by the service provider). For example, if a privilege exists specially during the time-zone, the information is given the priority, and information usable in a place nearer to the guessed place is given the priority, and information whose matching extent with the guessed behavior is high is given the priority, thereby making the selection range narrower. Conversely, if there exists no or there exist a few advertisements selected, the selection range is made wider so that the number becomes the suitable number. For example, even if there exists no such fitted advertisements in the neighborhood of the guessed place, a plurality of advertisements are selected in an order starting from an advertisement nearest to the guessed place. Moreover, even if there exists none of the advertisements that match the guessed behavior, advertisements related with the behavior are selected. Furthermore, the advertisements selected in the above-described manner are inserted as the advertisements into the vacant time that is being processed at present.

Additionally, here, it is preferable to select a plurality of advertisements and further, to classify the advertisements into the most suitable one and the other ones or to set the priority-orders thereto. Selecting the plurality of advertisements makes it possible to leave alternatives for permitting the user to select an advertisement. In addition, presenting first the most suitable or the highest priority-order advertisement to the user makes it possible to enhance the ease-of-use on the part of the user and the advertisement utilization-ratio thereby.

Also, the notion of advertisements, which is interpreted in the largest possible meanings, includes commodities, services, advertisements of the Web sites, event information, letting the world know widely, and the like. Moreover, such information as news, weather forecast, fortune telling, traffic information, “What day is today?”, and the like are regarded as the advertisements, thereby being able to be inserted into the vacant time.

At the step 2614, the service server judges whether or not an unprocessed vacant time exists. If the unprocessed vacant time exists, the processing goes back to the step 2610, then repeating the above-described processing toward the vacant times. If the unprocessed vacant time does not exist, the processing goes to a step 2615.

At the step 2615, the service server creates an answer pack, transmitting the answer pack to the mobile information terminal. This is the same step as that of the 1st embodiment. The answer pack may be created and transmitted on each unit-schedule basis as illustrated in FIG. 17, or the answer pack of all the unit schedules within the received time-period may be created and transmitted in a summarized manner.

At a step 2616, the mobile information terminal receives this answer packs. At a step 2617, the mobile information terminal stores this received answer packs into the recording unit 102. At a step 2618, when starting up an application for the schedule table so as to cause the schedule to be displayed, the mobile information terminal displays the schedule-related information and the advertisement included in the answer pack in association with the corresponding schedule. As is the case with the 2nd embodiment, displaying in associated manner means the following: On the calendar display of the schedule table, regarding the unit schedule, a mark or the like for indicating that the schedule-related information is added to the unit schedule is displayed on the periphery of the unit schedule. Regarding the vacant time, the advertisement itself, a downsized-version of the advertisement, a mark for indicating the existence of the advertisement, or the like is displayed in the vacant time. Meanwhile, on the detailed display of the schedule table, regarding the unit schedule, the contents thereof and the contents of the schedule-related information are displayed. Regarding the vacant time, the advertisement inserted therein is displayed.

Additionally, there are some cases where the user wishes to browse only the user's own schedule, and accordingly it is made possible to switch the display/non-display of the advertisement at any time. Also, as the method of displaying the advertisement, in the case where the plurality of advertisements have been inserted, only the most suitable advertisement or the highest priority-order advertisement is displayed first and at the same time, a mark or the like for displaying the remaining advertisements can also be displayed. In this case, when the mark is selected by the user operation, the remaining advertisements are displayed. Also, a unit schedule that the user is going to input is given a higher-priority than an advertisement. Namely, if the user tries to input the unit schedule into the portion of the vacant time in which the advertisement has been embedded, the advertisement will be switched onto the non-display or will be deleted. Otherwise, if the advertisement is an advertisement movable to before and after the vacant time, the advertisement may be moved thereto.

Also, although, in the present embodiment, the explanation has been given such that the advertisements will be inserted into all the vacant times, the inserting method is not necessarily limited thereto. For example, it is also possible for the service server to arbitrarily thin out the vacant times (e.g., the advertisements are inserted into only either of two vacant times, or the advertisements are inserted into each vacant time with a constant probability). In this case, when the service server specifies the vacant times at the step 2610, the server does not specify all the vacant times but specifies the vacant times while thinning out them as described above. Also, it is well to permit the user to select whether or not to insert the advertisements. As this selection, it is possible not to insert the advertisements at all into the respective vacant times, or it is possible to make a selection as to whether or not to insert the advertisements on each vacant-time basis. In the former case, the service server performs none of the processings at the steps 2610 to 2614. In the latter case, the following processing is performed, for example: The user in advance sets into which time-zone the user will insert the advertisements on a weekly basis, and into which time-zone the user will not. For example, the following setting is given beforehand: No advertisements will be inserted into the time-zone from 9 to 17 o'clock on weekdays (because the user stays at the company) and the time-zone from 24 to 6 o'clock on Fridays (because the user is sleeping), but the advertisements will be inserted into the other time-zones. This setting is stored into the mobile information terminal and, when transmitting the schedule pack, the terminal transmits this setting in a manner of being included in the schedule pack. The service server temporarily stores this setting included in the schedule pack. Then, when specifying the vacant times at the step 2610, the service server does not specify a vacant time existing in the time-zone into which no advertisements are set to be inserted, and specifies only a vacant time existing in the time-zone into which the advertisements are set to be inserted.

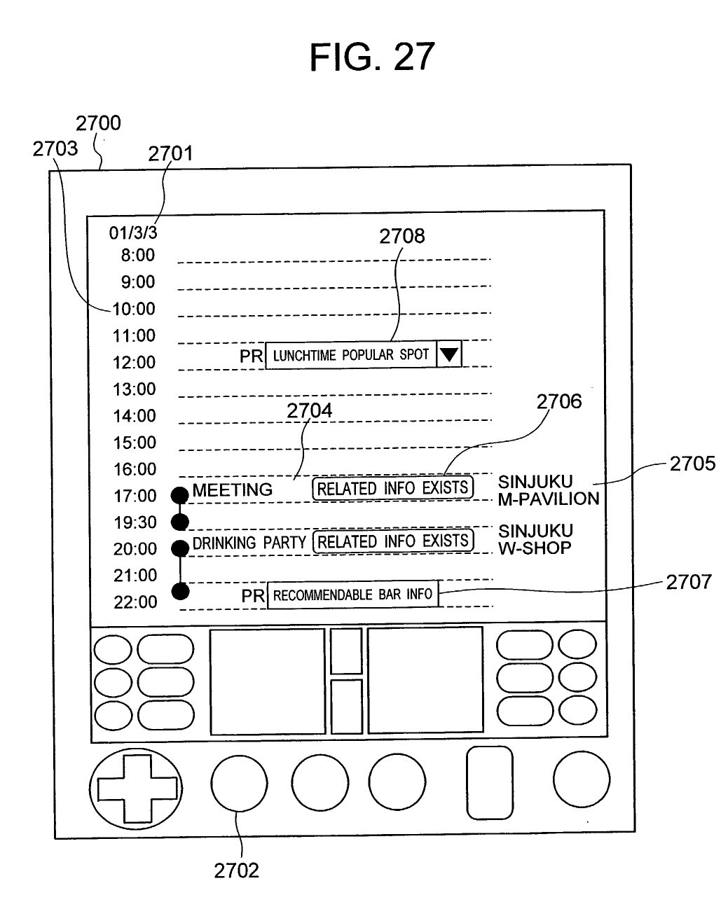

FIG. 27 is a diagram for illustrating an example of a display picture on the calendar display of the schedule table in the mobile information terminal in the 3rd embodiment. In FIG. 27, numerals 2701 to 2705 correspond to the numerals 200 to 205 in FIG. 2, and thus the explanation will be omitted. A numeral 2706 denotes a mark for indicating that the schedule-related information has been added to the schedule to which this mark is added. A numeral 2707 denotes an advertisement inserted by the service server. In order to distinguish between the schedule inputted by the user and the advertisement inserted by the service server, the displaying method is changed. Here, a “PR” mark is added to the advertisement and thus, just seeing this mark makes the user recognize that this is the advertisement. It is also well to distinguish between them by changing the characters' size, color, font, or position. A numeral 2708 also denotes an advertisement inserted by the service server. This advertisement is configured as the pull-down system, and accordingly the expansion of the advertisement makes it possible to see a plurality of advertisements and to make the selection. Since, as described earlier, the plurality of advertisements have been selected, of the advertisements, the most suitable or the highest priority-order advertisement is displayed first, and the remaining advertisements are displayed when the advertisement is expanded.

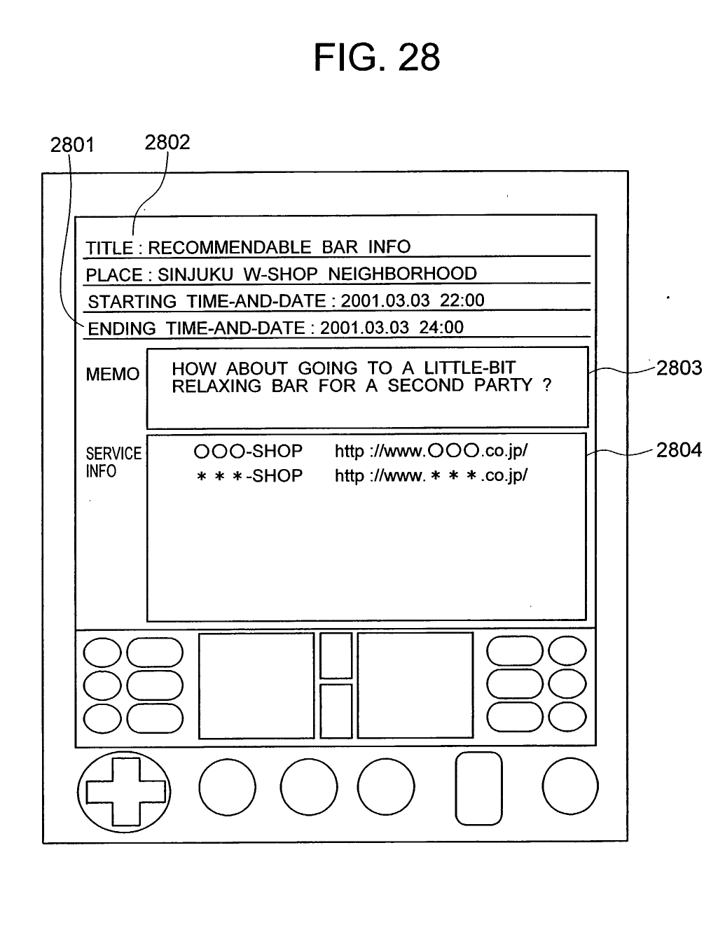

FIG. 28 is a diagram for illustrating a display example of the detailed-picture of an advertisement of the schedule table in the mobile information terminal in the 3rd embodiment. In the 3rd embodiment, an advertisement has a data configuration similar to that of a unit schedule, i.e., the data configuration including the time-and-date, the place, and the contents. This allows the advertisement to be displayed similarly to the usual unit schedule. Moreover, as the service information, the plurality of advertisements selected and their respective WEB information are displayed as described above.

Incidentally, the advertisement displaying method is not limited to the method as illustrated in FIG. 28, and thus another method is allowable. For example, selecting an advertisement on the calendar display permits the user to directly link to the Web site of the advertisement, although the detailed-picture is not displayed.

According to the 3rd embodiment explained so far, the user, the WEB manager, and the service provider can all obtain the same effects as those of the 2nd embodiment. Moreover, concerning the vacant time into which the user has not inserted the schedule, the advertisement selected as a result of having guessed the time, the place, and the user's behavior is inserted therein. Consequently, the user can easily obtain the information for effectively utilizing the vacant time. Regarding the vacant time into which the user has not inserted the schedule, the WEB manager inserts therein an advertisement having a high probability of being utilized by the user, thereby making it possible to perform the advertising activity of the WEB more effectively. The service provider can collect, from the WEB manager, not only the WEB-advertising activity supporting charge but also the advertisement charge. Also, the service provider makes free of charge the information providing charge from the user under a condition that the user will permit the insertion of the advertisement, thereby being capable of expecting an increase in the number of the utilizing users. These transactions allow the service provider to make a profit. Furthermore, even for a person who does not use the mobile information terminal so often or a person who does not input the schedule into the schedule table so frequently and diligently, a pleasure of using the mobile information terminal is increased because the suitable advertisement is inserted into the vacant time in the schedule table.

Next, the explanation will be given below concerning a 4th embodiment. The 4th embodiment is substantially the same as the above-described 1st to 3rd embodiments. The point that differs basically is a point that, although the mobile information terminal stores the schedule data in the 1st to 3rd embodiments, the service server stores the schedule data in the 4th embodiment.

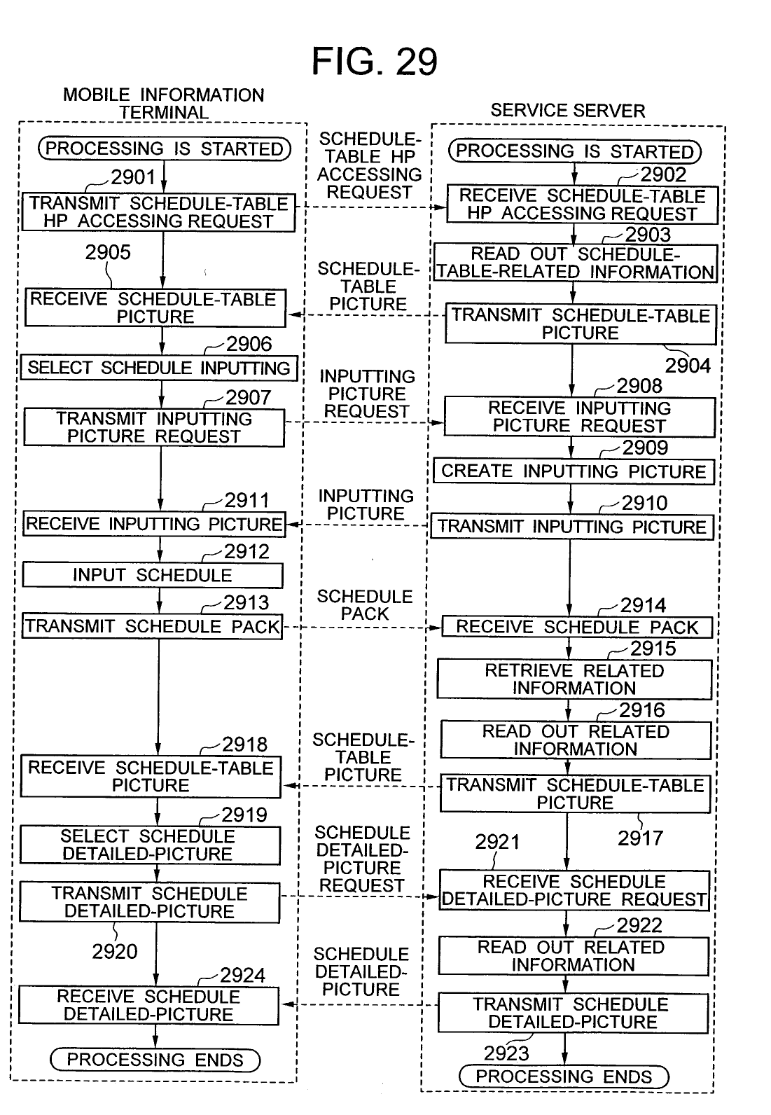

FIG. 29 is a diagram for showing a flow chart for the mobile information terminal and the service server in the 4th embodiment.

At first, at a step 2901, the mobile information terminal accesses a schedule table home page of the service server. At a step 2902, the service server receives the access to the schedule table home page from the mobile information terminal. At a step 2903, the service server reads out the schedule table data on the user from the schedule table database, thereby creating a schedule table picture. As is the case with the 3rd embodiment, the schedule table database has already included the pre-registered schedule data, the pre-retrieved schedule-related information, and the pre-inserted advertisements. The service server reads out these pieces of data, thereby creating the schedule table picture. The schedule table picture is, for example, the picture as illustrated in FIG. 27. Here, the schedule table picture is displayed on a daily basis and thus, on the first display resulting from the access from the user, a schedule table of “today” is displayed. Additionally, the schedule table picture may also be displayed on a weekly basis, a monthly basis, or a yearly basis instead of the daily basis and thus, the first display is not limited to “today” but may be another day such as the day of the last display. Also, the display of the daily basis, the weekly basis, the monthly basis, or the yearly basis can be freely switched by a predetermined operation by the user. At a step 2904, the service server transmits the created schedule table picture to the mobile information terminal.

At a step 2905, the mobile information terminal receives and displays the schedule table picture. At a step 2906, the user selects a schedule inputting. The selection of the schedule inputting is performed as follows: When the schedule table picture is displayed on the daily basis, the starting time of a schedule to be inputted is clicked and, when the picture is displayed on the weekly basis, the monthly basis, or the yearly basis, the date of the schedule to be inputted is clicked. Also, although not illustrated, a “schedule inputting” button may be provided, and the selection of the schedule inputting may be performed by clicking this button. At a step 2907, the mobile information terminal transmits a request for a schedule inputting picture to the service server. At this time, the terminal also transmits, to the service server, the information existing already as the schedule data. For example, if the starting time has been clicked, the data on the date and the starting time is transmitted. If the date has been clicked, the date is transmitted. Incidentally, although the explanation has been given here such that the date is clicked as the schedule inputting in the case of the weekly basis, the monthly basis, or the yearly basis, when the date has been clicked, the schedule inputting may be selected by switching the display into a display on a daily basis on the date and clicking the time.

At a step 2908, the service server receives the request for the schedule inputting picture. At a step 2909, the service server creates the schedule inputting picture. This picture, in the case of a new schedule inputting, is the picture in FIG. 25 or FIG. 28 where the respective items have been made into vacant fields. Additionally, when the date or the starting time is received as described above, a schedule inputting picture into which the date or the starting time has been inputted in advance is created. At a step 2910, the service server transmits the created schedule inputting picture to the mobile information terminal.

At a step 2911, the mobile information terminal receives and displays the schedule inputting picture. At a step 2912, the user inputs the schedule. This schedule inputting is performed by inputting the schedule into the vacant fields on the picture in FIG. 25 or FIG. 28, or by editing the already inputted date or starting time. At a step 2913, the mobile information terminal creates a schedule pack from the inputted unit schedule, then transmitting the schedule pack to the service server.

At a step 2914, the service server receives the schedule pack. At a step 2915, the service server retrieves WEB information related with the unit schedule data included in the schedule pack, and also selects a suitable advertisement for a newly generated vacant time so as to insert the advertisement therein. This retrieval of the schedule-related WEB information and this selection/insertion of the advertisement are the same as those in the 3rd embodiment. The service server stores the schedule-related WEB information and the advertisement into the schedule table database in a state of being made related with the schedule table data on the user. At a step 2916, the service server reads out the schedule table data on the user from the schedule table database, thereby creating a schedule table picture. At this time, as is the case with the step 2903, the server reads out the pre-registered schedule data, the pre-retrieved schedule-related information, and the pre-inserted advertisements stored in the schedule table database, thereby creating the schedule table picture. Naturally, since the schedule table database at this time has included the schedule data, the schedule-related information, and the advertisement stored at the step 2915, the above-described new schedule inputting is reflected on the schedule table picture created here. At a step 2917, the service server transmits this created schedule table picture to the mobile information terminal.

At a step 2918, the mobile information terminal receives and displays the schedule table picture that the service server has transmitted. This schedule table picture is similar to that in FIG. 27. At a step 2919, the mobile information terminal selects a schedule detailed-picture. The selection of the schedule detailed-picture is performed by selecting a displayed schedule or advertisement. This selection is performed in order to confirm or edit the details of the schedule or the advertisement. At a step 2920, the mobile information terminal transmits a request for the schedule detailed-picture to the service server.

At a step 2921, the service server receives the request for the schedule detailed-picture. At a step 2922, the service server reads out, from the schedule table database, schedule table data, schedule-related WEB information, and an advertisement corresponding to this schedule detailed-picture requested by the user, thereby creating the schedule detailed-picture. At a step 2923, the service server transmits this created schedule detailed-picture to the mobile information terminal.

At a step 2924, the mobile information terminal receives and displays the schedule detailed-picture that the service server has transmitted. The schedule detailed-picture is similar to that in FIG. 28. This schedule detailed-picture allows the user to confirm the details of the schedule or the advertisement. Also, on the schedule detailed-picture, its respective items are made editable and thus the user can edit its items if necessary. The editing flow is similar to the flow for the new schedule inputting (i.e., the steps 2912 to 2918). Namely, the user edits the respective items and clicks an “OK” button, which transmits, to the service server, the contents after having been edited. Having received this contents, the service server retrieves the schedule-related WEB information on the basis of the new contents and, if a vacant time is newly generated, the server inserts a suitable advertisement into this vacant time. The service server reads out again, from the schedule table database, the schedule table data, the schedule-related information, and the advertisement, thereby creating a schedule table picture so as to transmit this picture to the mobile information terminal. The mobile information terminal receives and displays this picture.

According to the 4th embodiment explained so far, the user, the WEB manager, and the service provider can all obtain the same effects as those of the 3rd embodiment. Moreover, the user needs to have neither the schedule table software nor the schedule table data within the mobile information terminal. This makes a contribution to a reduction in the usage amount of the memory capacity. The schedule table data has been stored in the service server. This also results in an effect that the user can access the service server from whatever terminal so as to manage the user's own schedule. The service provider holds the schedule table data on the user in the schedule table database and thus imposes no burden on the user, thereby making it easier to acquire new users. Also, for both the user and the service provider, the data size transmitted/received at one time becomes smaller than that in the 3rd embodiment. This results in an effect of saving the communications charge.

Next, the explanation will be given below concerning a 5th embodiment. The 5th embodiment is an embodiment resulting from improving the above-described 3rd embodiment one more step. The point that differs basically is a point that, even if there exists none of the schedule table inputting by the user, the information such as the advertisements are delivered and displayed on the schedule table of the user.

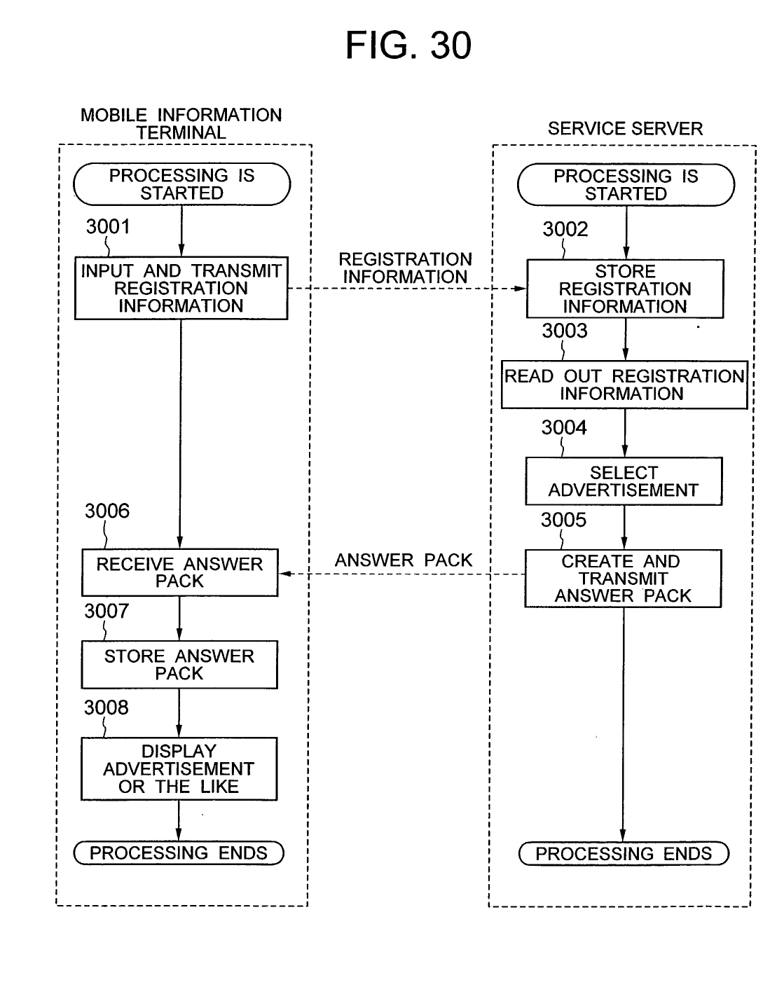

FIG. 30 is a diagram for showing a flow chart for the mobile information terminal and the service server in the 5th embodiment.

At first, at a step 3001, the user inputs registration information. The registration information refers to the user's personal information such as the user's age, name, address, gender, telephone number, taste, and hobby. The registration information includes information for indicating what type of advertisement the user wishes to be delivered, e.g., information on automobiles or information intended for children. Also, the user can specify a company that the user likes or dislikes, an advertising agency for performing the delivery of the advertisement, and the like. The registration information also includes information for indicating whether or not the user specifies the name of a magazine and wishes the reception of information publicized on the magazine. These pieces of registration information inputted are transmitted to the service server. At a step 3002, the service server stores the received registration information. At a step 3003, the service server reads out the registration information from the recording unit. These steps 3001 to 3003 will do if they are lacking. In that case, the processing is started from a step 3004. At the step 3004, the server selects an advertisement to be transmitted to the mobile information terminal. In the case where there exits the registration information, the server selects an advertisement related with the registration information. For example, if the user's registration information indicates that the user wishes an advertisement of automobiles to be delivered, the server selects an advertisement related therewith such as an automobile exhibition. As another method at the step 3004, based on the registration information, the server may judge whether or not the user will necessitate the advertisement that the server had beforehand wished and decided to deliver at the processing starting time. For example, if the service server had wished to deliver bargain information at the processing starting time, the processing is ended at the step 3004 with respect to a user who, according to the specification by the registration information, does not wish the delivery of the bargain information. At a step 3005, the service server, based on the advertisement selected at the step 3004, creates an answer pack, then transmitting the answer pack. At a step 3006, the mobile information terminal receives the answer pack. At a step 3007, the mobile information terminal stores the answer pack. At a step 3008, based on the received answer pack, the mobile information terminal displays the advertisement or the like on the schedule table. The displayed picture example thereof is similar to the advertisement 2707 or 2708 in FIG. 27. The processing is ended here.

Incidentally, the timings of the advertisement delivery are as follows: The one timing is that, as soon as the advertisement delivery gets ready, the delivery is performed immediately. Namely, at the time when an advertisement is registered into the recording unit in the service server and a state of being able to perform the delivery is prepared, the delivery is performed immediately.

Also, it is possible to await the delivery until a determined time-and-date. For example, the timing of an advertisement delivery can be estimated and specified such that the delivery will be performed 5 minutes before the starting of a bargain. This timing of performing the advertisement delivery may be registered beforehand into the service server or, when a message for instructing the advertisement delivery is received from, for example, a terminal that a clerk uses, the advertisement delivery may be performed. Also, the advertisement delivery can be performed under a condition of taking the network traffic into consideration. For example, the service server monitors the network traffic and, when a condition determined in advance is satisfied, the server may perform the advertisement delivery. Also, of course, the time-and-date alone can be set as the condition of the timing of performing the advertisement delivery. Namely, when there comes a time-and-date determined in advance, the advertisement is delivered.

Otherwise, the advertisement delivery may be performed at the time when the advertisement has gathered by a predetermined quantity. This method is effective when delivering a plurality of advertisements collectively. Also, at this time, the plurality of advertisements can be delivered in a state of being collectively compressed.

Also, although, in the explanation given so far, the explanation has been given such that the answer pack is transmitted, the following method is also allowable: Namely, as the information to be delivered, there exist an advertisement and information that accompanies the advertisement. Hereinafter, the explanation will be given below concerning each of them.

At first, as the advertisement, there may exist an advertisement including characters, an advertisement including images, voices, music, or motion pictures. Moreover, as the method of presenting the advertisement, a script such as a blink may be included.

Also, as the information that accompanies the advertisement, there exist information on the time-and-date when the advertisement should be displayed, the advertisement type, information for specifying the delivering source of the advertisement, and the like. When the terminal displays the advertisement on the schedule table, the time-and-date when the advertisement should be displayed is used for determining the position on which the advertisement should be displayed. Additionally, the time-and-date when the advertisement should be displayed need not necessarily include both the date and the time. For example, the time-and-date when the advertisement should be displayed includes the date alone, and the time can be specified on the terminal side. Conversely, the time-and-date when the advertisement should be displayed includes the time alone, and the date can be specified on the terminal side. The advertisement type refers to information about what the contents thereof is, for example, the information on automobiles and information on eating and drinking shops.

Moreover, the information for specifying the delivering source of the advertisement can be used in the following way, for example. At first, the user registers the advertisement delivering source. In this registration, for example, the user accesses the home page of the advertisement delivering source, and the user and the advertisement delivering source make a contract about the advertisement delivery, and then the advertisement delivering source acquires a password for displaying the advertisement on the terminal. Furthermore, the advertisement delivering source delivers the advertisement on the so-called broadcasting basis without specifying the user. It is allowable, however, to specify the user. In addition, only the advertisement including the password for displaying the advertisement on the terminal is displayed on the schedule table in the terminal.

Also, the advertisement to be delivered may also be made compliant with the data format of the schedule table. By doing this, it becomes possible to easily display the advertisement on the schedule table. Also, the advertisement displayed on the schedule table can be linked. In this case, selecting the advertisement starts up an application such as the browser, and the advertisement may be displayed on this application.

Also, the advertisement and the information on the advertisement type are delivered, and the terminal side can be permitted to make a judgement as to whether or not to display the advertisement. Namely, information equivalent to the user's registration information is beforehand stored into the terminal. Then, the information on the advertisement type, which accompanies the received advertisement, and the user's registration information are compared with each other, and the advertisement is displayed if the advertisement is found to be a one that the user wishes to be displayed. For example, the user's taste is registered beforehand, and it is possible to display only an advertisement that meets the user's taste.

Also, the terminal side can also be permitted to set up where to display the received advertisement. For example, in the case of a user whose golden time is Friday nights or noon to evening on Saturdays/Sundays, it is also possible to display, in this time-zone, an advertisement that meets the user's taste best of all.

In this case, the server delivers the advertisement accompanied by the information on the advertisement type. In addition, the terminal makes a comparison between the received information on the advertisement type and, for example, the information on the taste included in the user's registration information stored in advance, thereby determining the place in which to display the advertisement. As the place determining method, at first, a time-zone corresponding to the user's taste is prepared. The user may create this time-zone, or may download the time-zone that the service provider has created. Namely, the time-zone during which the advertisement should be displayed is set up as follows: For example, in the case of the information on eating and drinking shops, the information is displayed on Friday nights and, in the case of information on an event to be performed outdoors, the information is displayed at noon on Sundays. Moreover, when the terminal has received the advertisement, in accordance with the information on the advertisement type and the prepared time-zone, the terminal determines the place in which to display the advertisement. Incidentally, in the case where a plurality of advertisements to be displayed exist in one and the same time-zone, the terminal makes a comparison between the information on the advertisement type and the user's registration information so as to set a higher priority-order in an order starting from an advertisement with the most items meeting the registration information, then displaying the advertisements in the order starting from the highest priority-order advertisement, or displaying only the highest priority-order advertisement.

Also, the terminal may make a judgement as to whether or not the place in which to display the advertisements is a vacant time. If no judgement is decided to be made, the advertisements may be displayed in parallel in a time-zone in which a schedule already exists. If the judgement is decided to be made, the advertisements may not be displayed in the time-zone in which the schedule already exists, or may be displayed in parallel therein.

Also, although, in the explanation given so far, the selection of the advertisement has been performed using the user's registration information, the selection can also be performed using another information. For example, an advertisement to which a recommendation from a friend has been attached may be displayed with the highest-priority. Otherwise, an advertisement fitted to the vogue or the trend may be displayed with the highest-priority.

According to the 5th embodiment explained so far, it is possible to present many advertisements to the user. This increases the merit of the advertising sponsor such as the WEB manager. Consequently, the service provider can receive the requests form many WEB managers. Also, in the case where the service to the user has been charged in the 1st to the 4th embodiments, the charge can be reduced or can be made free of charge.

The explanation has been given so far concerning the 1st to the 5th embodiments. The present invention, however, is not limited to these embodiments, and thus it is needless to say that a variety of embodiments can exist without modifying its essence.

Although, in the explanation given so far, the explanation has been given assuming that all the terminals that the users use are the mobile information terminals, a terminal is also allowable which can perform the data transmission/reception by establishing the connection with a personal computer or some other network. Of course, the mobile information terminals include a PDA, a mobile cellular phone, and a PHS.

Also, with respect to a timing with which the schedule data is transmitted to the service server after inputting the schedule data into the mobile information terminal, there exist several methods. For example, the schedule data can be transmitted immediately after the inputting. This method is excellent because the schedule-related information or the advertisement can be obtained right away. Otherwise, the data can be transmitted after waiting for a constant time-period to elapse after the inputting. Inputting a plurality of schedules for the constant time-period becomes a one-time transmission, and thus this method is convenient and saves the communications cost. Otherwise, the data can be transmitted when the schedule table has been finished. This, even when a plurality of schedules are inputted while spending the time, becomes a one-time transmission, and thus this method is convenient and saves the communications cost. Also, the data may be automatically transmitted at a predetermined time. For example, the data is transmitted at 0:00 every day, and the schedule-related information or the advertisement may be obtained concerning the schedules from tomorrow and thereafter. In this case, even if no schedule has been inputted into the schedule table for a long time-period, the advertisement is updated. Otherwise, a “transmission” button is provided, and the data may be transmitted by operating this button. This allows the user's will to be directly reflected.

Meanwhile, with respect to a timing with which the server transmits the schedule-related information or the advertisement to the mobile information terminal, there also exist several methods. For example, immediately after the server has retrieved the schedule-related information, the retrieval result can be transmitted. In this case, the user can know the retrieval result immediately, which is convenient. Otherwise, even if the server receives the schedule pack, instead of performing the processing right away, the server can perform the retrieval on a scheduled day or the day before so as to transmit the retrieval result to the mobile information terminal. In this case, the retrieval result becomes the newest one, thereby making it possible to provide more valid information. Otherwise, the data can be transmitted when the user finishes the schedule table once and opens the schedule table next. Since, in some cases, the user performs only the schedule inputting and finishes the schedule table without confirming the schedule table, the necessary information is not transmitted at that time but is transmitted in synchronization with the timing with which the user confirms the schedule table.

Also, many users, in many cases, open the schedule table in the morning in order to confirm the schedule on that day. Consequently, it is apprehended that the loads on the service server will be concentrated in the morning. In order to deal with this situation, during the midnight (e.g., 2:00 to 5:00), the transmission/reception of the schedule data, the schedule-related information, or the advertisement may be automatically performed between the mobile information terminal and the service server. Moreover, the following operation is also possible: A time stamp is attached to both the mobile information terminal and the service server. After that, when the user tries to confirm the schedule, the terminal transmits the time stamp as well. Moreover, the service server performs no processing if the time stamp that the server itself has stored and the received time stamp coincide with each other. This makes it possible to reduce the concentration of the loads in the morning.

Also, as the schedule-related WEB information, not only the home page related directly therewith but also information that allows the access to be made to the home page are allowable. Giving a concrete explanation concerning, for example, a restaurant, in addition to the home page that publicizes the schedule-related restaurant, a retrieval result itself obtained by performing the retrieval under a condition synchronized with the user's schedule at the retrieval site of the restaurant may also be defined as the schedule-related WEB information. Otherwise, a category related with the schedule at a directory-type retrieval site may also be defined as the schedule-related WEB information.

Also, in the explanation given so far, the user profile has been used when retrieving the schedule-related information or selecting the advertisement. The user profile refers to the various information on the user, the examples of which are as follows: The personal information such as the user's name, address, contact address, date of birth, age, gender, occupation, and office location, the taste information such as the user's favorite object, favorite place, and interest or hobby, and the history information, i.e., the accumulation of the schedule data on the user so far, statistics information obtained from the history information, and commemoration-day information such as the user's birthday and wedding anniversary. Incidentally, it is advisable that the user registers these pieces information when making the user registration first. Otherwise, it is also advisable that the mobile information terminal has stored these pieces of information beforehand, and transmits the information to the service server as required.

Also, the service provider creates a home page or a brochure such as a catalogue for publicizing the service contents that the service provider itself offers, thereby advertising the service. This can be done in the following way, for example: The link to the user registering picture has been set up on the home page. The user browses this home page so as to know the service contents, then jumping up to the user registering picture so as to make the user registration. Also, the home page publicizes an explanation intended for the other WEB managers, and includes a link to a WEB manager registering page as well. The WEB managers understand the service contents by this explanation, then making the registrations on the WEB manager registering page. Also, the service provider may work upon the WEB managers to encourage the WEB managers to make the registrations.

Also, although, in the explanation given so far, no schedule table software has been specified, concretely speaking, the schedule table software is implemented in the following way: For example, a schedule table software preferable to the present invention is installed into the mobile information terminal. In addition to the functions of the usual schedule table software, this software owns the above-described functions of the present invention. Otherwise, the usual schedule table software is employed as the schedule table software and further, an auxiliary software such as a plug-in for adapting the schedule table software to the present invention can be installed. Additionally, these softwares are stored into a computer-readable storage medium so as to be distributed, or are distributed from the server to the information terminal device via the network. Terms relating to device or machine “readable medium” as used herein refer to any medium that participates in providing instructions and/or data to programmable processor (CPU) for execution or other processing. Such a medium may take any forms, including but not limited to, non-volatile media, volatile media, and transmission media. Non-volatile media include, for example, optical or magnetic disks, such as ROM, or Hard disc described in the recording unit 102. Volatile media include dynamic memory, such as RAM described in the recording unit 102. Physical transmission media include coaxial cables; copper wire and fiber optics. Transmission media can also take the form of electric or electromagnetic signals, or acoustic or light waves such as those generated during radio frequency (RF) and infrared (IR) data communications.

Common forms of device (device, e.g., information terminal device or server) readable media include, for example, a flexible disk, hard disk, magnetic medium, a CD-ROM, DVD, any other optical medium, RAM, a PROM, and EPROM, a FLASH-EPROM, any other memory chip or cartridge, a carrier wave transporting data or instructions, or any other medium for which an information terminal device can read. Various forms of machine-readable media may be involved in carrying one or more sequences of one or more instructions to CPU 101 for execution. Incidentally, the softwares refer to the programs for the operations of the computer.

Also, the user authentication may be performed when the user terminal accesses the service server, although, in the explanation given so far, the user authentication has been omitted. For example, at the time of the user registration, the user authentication information such as a user ID and a password are given in advance to each user. Then, at the time of the user authentication, a user inputs the user authentication information such as the user ID and the password. Making reference to the user file that stores the information on the users, the service server judges whether or not the user authentication information such as the user ID and the password is authorized information. If the authentication information is the authorized one, the server judges that the user is a justifiable user. This makes it possible to prevent an unauthorized behavior by an unjustifiable user.

Also, although, in the explanation given so far, the operation referred to as “the click” has been used in the user operation, this is for the sake of convenience. In the case of a touch panel, “a tap” is allowable, and further, another key operation is also allowable.

Also, although, in the explanation given so far, the term of “the schedule-related information” and that of “the schedule-related WEB information” have been used, these terms mean “the information related with the schedule” and thus are the same as the service information, i.e., the open/close times of a shop, the location of a scenic spot, the summary or the original of information such as news, and information including the link to a Web site where the information is available.

Also, although, in the explanation given so far, the advertisement is automatically inserted into the schedule table, the advertisement can also be inserted using another method. For example, as is the case with the method explained so far, the service server selects an advertisement that is suitable for being inserted into the vacant time of the user. The service server does not insert the advertisement immediately into the schedule table, but delivers the advertisement to the user by a mail. A link for inserting the advertisement into the schedule table has been set up within the schedule table. Clicking this link makes it possible for the user to insert the advertisement into the schedule table. Explaining in more detail, when the mobile information terminal has stored the schedule data, clicking the link opens the schedule table in the mobile information terminal, then inserting the advertisement into a predetermined vacant time. Also, when the service server has stored the schedule data, clicking the link causes the mobile information terminal to access the service server and to open the schedule table home page, then inserting the advertisement into a predetermined vacant time. Clicking the link in this way allows the user to see the advertisements by the mail first, thereby permitting the user to insert only a necessary advertisement into the schedule table. Also, the service provider leaves the selection of the advertisement insertion to the user's judgement, thereby making it possible to offer a more fulfilling service.

Also, although, in the explanation given so far, the mobile information terminal, the service server, and the contents servers are devices that have at least either of the server function and the client function in the Server-Client Model. The mobile information terminal, the service server, and the contents servers may be in a mutually equal relationship. The equal relationship means that each of the devices has both the server function and the client function. The equal relationship among them may be implemented using the peer-to-peer technology.

Also, although, in the explanation given so far, the mobile information terminal, the service server, and the contents servers need not exist as the devices, but may exist as software programs. For example, the mobile information terminal, the service server, and the contents servers may exist as a mobile-information-terminal function software, a service-server function software, and contents-server function softwares, respectively.

According toabove described embodiments, in the mobile information terminal device, the user can make the user's own schedule information available to the user by the simplified operation in a short time. The WEB manager can perform the advertising activity of the manager's own Web site to the mobile information terminal in synchronization with the user's schedule. Moreover, the service server can provide the service that is charming to both the user and the WEB manager.

While the foregoing has described what are considered to be the best mode and/or other preferred embodiments, it is understood that various modifications may be made therein and that the invention or inventions disclosed herein may be implemented in various forms and embodiments, and that they may be applied in numerous applications, only some of which have been described herein. It is intended by the following claims to claim any and all modifications and variations that fall within the true scope of the inventive concepts.

What is claimed is:

1. An information terminal device for communication via a network, comprising:
a memory for storing schedule data;
a controller which forms a schedule pack based on the schedule data;
a communication module, coupled to the controller, which transmits the schedule pack to a server via the network, and receives schedule-related information retrieved by the server via the network; and
a display for displaying received schedule-related information.

2. The information terminal device according to claim 1, wherein:
the memory stores a program for managing the schedule data including at least any one of the scheduled-time, the scheduled-place, or the scheduled-content, inputted by a user; and
the controller extracts data from the stored schedule data to form the schedule pack.

3. The information terminal device according to claim 2, wherein:
the controller forms the schedule pack by adding identification to the extracted data, the identification being identifiable within the information terminal device itself.

4. The information terminal device according to claim 1, wherein:
the communication module specifies a position of the information terminal device and transmits the specified position information to the server on the network.

5. The information terminal device according to claim 1, wherein:
the memory stores a dictionary;
the controller references the dictionary and extracts a word as a schedule-searching keyword from the schedule data; and
the communication module transmits the schedule pack, including the schedule-searching keyword, to the server.

6. The information terminal device according to claim 1, wherein:
the display displays a schedule table comprising the schedule-related information in association with related schedule data.

7. The information terminal device according to claim 6, wherein:
the communication module receives information relating vacant time of the schedule data retrieved by the server; and
the display displays the schedule-related information and the information relating the vacant time with the schedule table.

8. A portable information terminal device which is able to communicate via a network, comprising:
a memory for storing schedule data;
a controller which forms a schedule pack based on the schedule data;
a wireless transceiver which transmits the schedule pack to a server via the network, and receives schedule-related information retrieved by the server via the network; and
a display for displaying received schedule-related information.

9. The information terminal device according to claim 8, wherein:
the memory stores a program for managing the schedule data including at least any one of the scheduled-time, the scheduled-place, or the scheduled-content, inputted by a user; and
the controller extracts data from the stored schedule data to form the schedule pack.

10. The information terminal device according to claim 9, wherein:
the controller forms the schedule pack by adding identification to the extracted data, the identification being identifiable within the information terminal device itself.

11. The information terminal device according to claim 8, wherein:
the display displays a schedule table comprising the schedule-related information in association with related schedule data.

12. The information terminal device according to claim 11, wherein:
the wireless transceiver receives information relating vacant time of the schedule data retrieved by the server; and
the display displays the schedule-related information and the information relating the vacant time with the schedule table.

13. A portable terminal device, comprising:
a communication module which transmits at least part of a user's calendar data, and receives schedule-related information relating to the calendar data, the schedule-related information being retrieved using the calendar data; and
a display which displays the received schedule-related information.

14. A portable terminal device according to claim 13, further comprising:
a memory for storing a user's calendar data and a program for managing the user's calendar data.

15. A portable terminal device, comprising:
a communication module which transmits at least part of a user's calendar data, and receives schedule-related information retrieved with respect to the calendar data and made related to the calendar data; and
a display which displays the received schedule-related information in association with the calendar data.

16. A portable terminal device according to claim 15, further comprising:
a memory for storing a user's calendar data and a program for managing the user's calendar data.

17. An information terminal device, comprising:
a communication module which receives an advertisement and information on time-and-date when the advertisement should be displayed;
a controller which determines a position at which the received advertisement should be displayed within a schedule table in accordance with the information on the time-and-date when the received advertisement should be displayed; and
display for displaying the advertisement at the determined position within the schedule table.

18. An information terminal device according to claim 17, further comprising:
a memory for storing the schedule table as a user's calendar data and a program for managing the user's calendar data.

19. A server which is able to communicate with an information terminal device via a network, comprising:
a storage device for storing information;
a communication module, coupled to the controller, which receives a schedule pack including user's calendar data from the information terminal device via the network; and
a controller retrieves schedule-related information related to the user's calendar data from the storage device based on the received schedule pack,
wherein the communication module transmits the schedule-related information to the information terminal device via the network.

20. The server according to claim 19, wherein:
the controller extracts a schedule-searching keyword from the schedule pack; and
the controller retrieves schedule-related information by using the schedule-searching keyword.

21. The server according to claim 19, wherein:
the storage device stores a dictionary, and
the controller references a dictionary and extracts a word as a schedule-searching keyword from the schedule pack, and
retrieves schedule-related information by using the schedule-searching keyword.

22. The server according to claim 19, wherein:
the controller generates charge information for providing schedule-related information.

23. The server according to claim 19, wherein:
the retrieved schedule-related information includes at least one of URL of a Web site, a summary, a part, or an original of information.

24. The server according to claim 23, wherein:
the controller creates a summary of the schedule-related information, and
the communication module transmits the summary of the schedule-related information to the information terminal device.

25. The server according to claim 19, wherein:
the communication module transmits the schedule-related information, and an association of the calendar data, so that the information terminal device can display the calendar data and the schedule-related information in association with each other.

26. The server according to claim 19, wherein:
the controller retrieves information relating to vacant time indicated in the schedule data, and
the communication module transmits the information relating to vacant time with the schedule-related information.

27. An information delivering device, comprising:
a communication module which receives, from an information terminal device, at least one unit of schedule data that a user has inputted into the information terminal device;
a controller which retrieves schedule-related information by using the received unit of schedule data; and
a storage device which stores the unit of schedule data and the schedule-related information in association with each other; wherein:
the communication module receives, from the terminal device, a request for displaying the unit of schedule data,
the controller reads out the unit of schedule data and the schedule-related information from the storing unit, and creates image data containing the unit of schedule data and the schedule-related information for displaying in association with each other, and
the communication module transmits the image data to the terminal device.

28. The information delivering device according to claim 27, wherein:
the controller retrieves information relating to vacant time of the unit of schedule data, and stores the information relating to vacant time with the schedule-related information.

29. The information delivering device according to claim 27, wherein:
the controller deletes the schedule-related information when the schedule-related information is older than the day or time when the device received the request.

30. An information delivering method, at a server which is able to communicate with a terminal device via a network, comprising the steps of:
receiving a schedule pack including at least part of a user's calendar data from the terminal device;
searching schedule-related information related to the calendar data based on the received schedule pack; and
transmitting the schedule-related information to the terminal device.

31. An information delivering method, at a server which is able to communicate with a terminal device via a network, comprising the steps of:
receiving at least part of a user's calendar data transmitted from the information terminal device;
searching schedule-related information concerning the received calendar data; and
transmitting the schedule-related information in association with the calendar data so that the terminal device can display the calendar data and the schedule-related information in association with each other.

32. An information delivering method at a server which is able to communicate with a terminal device via a network, comprising the steps of:
receiving at least one unit of schedule data included in schedule table data stored in the terminal device, and at least one unit schedule identification for identifying the unit of schedule data, from the terminal device;
searching schedule-related information by using the received unit of schedule data; and
transmitting an identifier to the terminal device with the schedule-related information, so that the terminal device associates the unit of schedule data and the schedule-related information with each other.

33. An information delivering method according to claim 32, wherein:
the identifier is the unit schedule identification.

34. An information delivering method according to claim 32, wherein:
the identifier is different from the unit schedule identification, and created from the unit schedule identification and allowing the unit of schedule data to be identified.

35. An information delivering method, at a server which is able to communicate with a terminal device via a network, comprising the steps of:
receiving a schedule pack formed based on calendar data stored in the terminal device;
retrieving schedule-related information concerning the schedule pack and information concerning a vacant time of the calendar data; and
transmitting, to the terminal device, the schedule-related information and the information concerning vacant time of the calendar.

36. An information delivering method at a server which is able to communicate with a terminal device via a network, comprising the steps of:
receiving from the terminal device, a schedule pack formed based on calendar data stored in the terminal device; and
transmitting to the terminal device, schedule-related information being retrieved using the schedule pack, and an advertisement for placement in a time-zone of the calendar data having no schedule contents in the received schedule pack.

37. An information delivering method at a server which is able to communicate with a terminal device via a network, comprising the steps of:
receiving, from the terminal device, a schedule pack including at least part of schedule data inputted by an user of the terminal device;
storing received schedule data and schedule-related information into a schedule table in association with a unit of the schedule data;
reading at least part of schedule data and the schedule-related information from the schedule table database;
making image data for displaying a schedule table including the schedule data and the schedule-related information in association with each other; and
transmitting the image data to the terminal device.

38. The information delivering method according to claim 37, wherein:
the image data are created so that an advertisement is displayed in a time-zone into which the schedule data has been not inputted.

39. An information delivering method at a server which is able to communicate with a terminal device via a network, comprising the steps of:
receiving, at the server, user authenticating information from the terminal device;
performing, at the server, a user authentication by using the received user authenticating information;
reading out, at the server, at least part of user's schedule data from a schedule table database if the user is judged to be an authorized user by the user authentication;
creating, at the server, first image data for displaying a schedule table based on the user's schedule data;
transmitting, at the server, the first image data to the terminal device;
receiving, at the server, from the terminal device, at least part of schedule data inputted by a user of the terminal device;
storing, at the server, the schedule data inputted by the user and schedule-related information into the schedule table database in association with the user's schedule data to form an updated table; and
reading out, at the server, at least part of schedule data and the schedule-related information from the updated table database so as to create second image data such that the schedule data and the schedule-related information from the updated table enables a display in association with each other; and
transmitting the second image data from the server to the terminal device.

40. An information delivering method at a server which is able to communicate with a terminal device via a network, comprising the steps of:
reading out registration information on a user from a recording unit, the registration information being recorded in the recording unit;
selecting an advertisement by using the read-out registration information on the user;
generating information on time-and-date when the advertisement should be displayed; and
transmitting, to the terminal device, the advertisement and the information on the time-and-date when the advertisement should be displayed so that the terminal device will display the advertisement on a schedule table in accordance with the information on the time-and-date when the advertisement should be displayed.

41. A computer program product for an information terminal having communication and display capability, comprising:
at least one device readable medium;
programming code, carried by the at least one medium, for execution by a programmable processor of the terminal, wherein execution of the programming code by the programmable processor causes the terminal to implement a series of steps, comprising:
storing schedule data;
forming a schedule pack based on the schedule data;
transmitting the schedule pack to a server;
receiving schedule-related information retrieved by the server; and
displaying the received schedule-related information.

42. A computer program product according to claim 41, wherein: the forming step includes adding a unit of schedule identification to the schedule pack.

43. A computer program product for an information terminal having communication and display capability, comprising:
at least one device readable medium;
programming code, carried by the at least one medium, for execution by a programmable processor of the terminal, wherein execution of the programming code by the programmable processor causes the terminal to implement a series of steps, comprising:
storing schedule data;
forming a schedule pack based on the schedule data;
transmitting the schedule pack to a server;
receiving schedule-related information retrieved by the server;
storing the received schedule-related information in association with the schedule data used to form the transmitted schedule pack; and
displaying a schedule table with the schedule-related information relating to displayed schedule data included in the schedule table.

44. A computer program product for an information terminal having communication and display capability, comprising:
at least one device readable medium;
programming code, carried by the at least one medium, for execution by a programmable processor of the terminal, wherein execution of the programming code by the programmable processor causes the terminal to implement a series of steps, comprising:
storing schedule data;
forming a schedule pack based on the schedule data;
transmitting the schedule pack to a server;
receiving schedule-related information and information relating to vacant time of the schedule data retrieved by the server; and
displaying the schedule-related information and the information relating the vacant time with the schedule table.
